(19) United States
(12) Patent Application Publication
(10) Pub. No.: US 2024/0316760 A1
(43) Pub. Date: Sep. 26, 2024

(54) ROBOT, ROBOT SYSTEM, AND METHOD FOR CONTROLLING ROBOT

(71) Applicant: SEIKO EPSON CORPORATION, Tokyo (JP)

(72) Inventor: Yuki KIYOSAWA, Shiojiri-shi (JP)

(21) Appl. No.: 18/608,985

(22) Filed: Mar. 19, 2024

(30) Foreign Application Priority Data
Mar. 20, 2023 (JP) 2023-043905

(51) Int. Cl. B25J 9/16; B25J 9/12

(52) U.S. Cl. CPC B25J 9/1602; B25J 9/126; B25J 9/1633; B25J 9/1653; B25J 9/1674

(57) ABSTRACT

A robot includes a controllers and a monitoring section, wherein when causing the motor to execute a predetermined operation, the controller transmits a first control signal to the motor as the control signal, receiving a first output signal based on the first control signal as the output signal from an encoder, generates a second control signal in which the difference from the first output signal is smaller than a difference value that between the first control signal and the first output signal, and sending the second control signal to the motor and the monitoring section receiving the second control signal from the controller and comparing the difference between the second control signal and the output signal with the threshold.

### CROSS-REFERENCE TO RELATED APPLICATIONS

The present application is based on, and claims priority from JP Application Serial Number 2023-043905, filed Mar. 20, 2023, the disclosure of which is hereby incorporated by reference herein in its entirety.

### BACKGROUND OF THE INVENTION

### 1. Technical Field

The present disclosure relates to a robot, a robot system, and a method for controlling the robot.

### 2. Related Art

A servo system including a safety unit is known. The servo system described in JP-A-2011-192015 is used in a system for driving an arm of an industrial robot. The safety unit monitors that the servo motor is normally controlled. The safety unit is an example of a monitoring unit. The safety unit acquires a command value sent to the servo motor and a feedback value as a result of the servo motor being driven following the command value. The safety unit generates a stop signal when one or both of the command value and the feedback value are abnormal. A servo driver stops the supply of electric power to the servo motor in response to the stop signal. The safety unit stops the supply of electric power to the servo motor by transmitting the stop signal.

When the motor is stopped by stopping the supply of electric power, the stop position of the rotation shaft of the motor becomes unstable. In some cases, the stop position of the arm driven by the motor becomes unstable, and it takes time to restart the robot.

### SUMMARY OF THE INVENTION

A robot of the present disclosure includes a motor having a rotation shaft; a controller configured to transmit a control signal to the motor at a predetermined timing; an encoder that is configured to detect the operation of the motor based on the control signal and that is configured to output an output signal; and a monitoring section that is configured to receive the control signal and the output signal, that is configured to compare the difference between the control signal and the output signal with a predetermined threshold, and that is configured to output a power shutoff command when the difference is larger than the threshold, wherein when causing the motor to execute a predetermined operation, the controller transmits a first control signal to the motor as the control signal, receives a first output signal based on the first control signal as the output signal from the encoder, generates a second control signal in which the difference from the first output signal is smaller than a difference value that between the first control signal and the first output signal, and transmits the second control signal as the control signal to the motor and the monitoring section receives the second control signal as the control signal from the controller and compares the difference between the second control signal and the output signal with the threshold.

A robot system of the present disclosure includes a robot including a robot control device having a controller configured to transmit a control signal at a predetermined timing and a monitoring section that is configured to compare the difference between the control signal and an output signal based on the control signal with a threshold and that is configured to, when the difference is larger than the threshold, output a power shutoff command, a motor having a rotation shaft, and an encoder configured to output the output signal based on the control signal, wherein when causing the motor to execute a predetermined operation, the controller transmits a first control signal as the control signal, receives a first output signal based on the first control signal as the output signal from the encoder, generates a second control signal in which the difference from the first output signal is smaller than a difference value that between the first control signal and the first output signal, and transmits the second control signal as the control signal to the motor and the monitoring section receives the second control signal as the control signal from the controller and compares the difference between the second control signal and the output signal with the threshold.

A method for controlling a robot of the present disclosure, the robot including
a motor operating based on a control signal; an encoder that is configured to detect the operation of the motor based on the control signal and that is configured to output an output signal; and a monitoring section that is configured to compare a difference between the control signal and the output signal based on the control signal with a threshold and that is configured to, when the difference is larger than the threshold, output a power shutoff command, the method comprising: when executing a predetermined operation, transmitting a first control signal to the motor as the control signal, receiving a first output signal based on the first control signal as the output signal from the encoder, generating a second control signal in which the difference from the first output signal is smaller than the difference value that between the first control signal and the first output signal, transmitting the second control signal as the control signal to the motor, receiving a second output signal based on the second control signal as the output signal from the encoder, and comparing the difference between the second control signal and the output signal with the threshold.

### BRIEF DESCRIPTION OF DRAWINGS

FIG. 1 is a diagram showing a schematic configuration of a robot.

FIG. 2 is a diagram schematically showing the robot.

FIG. 3 is a diagram showing a schematic configuration of the motor unit.

FIG. 4 is a diagram showing a block configuration of the robot.

FIG. 5 is a diagram schematically showing a block configuration of the robot.

FIG. 6 is a diagram schematically showing a block configuration of the robot.

FIG. 7 is a diagram schematically showing a block configuration of the robot.

FIG. 8 is a diagram showing a controller control value and the like outputted at a predetermined timing.

FIG. 9 is a diagram showing the change of a rotational velocity of the output shaft with time.

FIG. 10 is a diagram showing a controller control value and the like outputted at a predetermined timing.

FIG. 11 is a diagram showing a control flow executed by the robot.

FIG. 12 is a diagram showing an example of a workpiece operation performed by the robot.

FIG. 13 is a diagram schematically showing a block configuration of the robot.

FIG. 14 is a diagram schematically showing a block configuration of the robot.

FIG. 15 is a diagram showing a controller control value and the like outputted at the predetermined timing.

FIG. 16 is a diagram schematically showing a change with time of the position of the component and the torque applied to the motor.

FIG. 17 is a diagram showing a control flow executed by the robot.

FIG. 18 is a diagram showing a schematic configuration of a robot system.

FIG. 19 is a diagram showing a block configuration of the robot system.

### DETAILED DESCRIPTION OF THE INVENTION

### First Embodiment

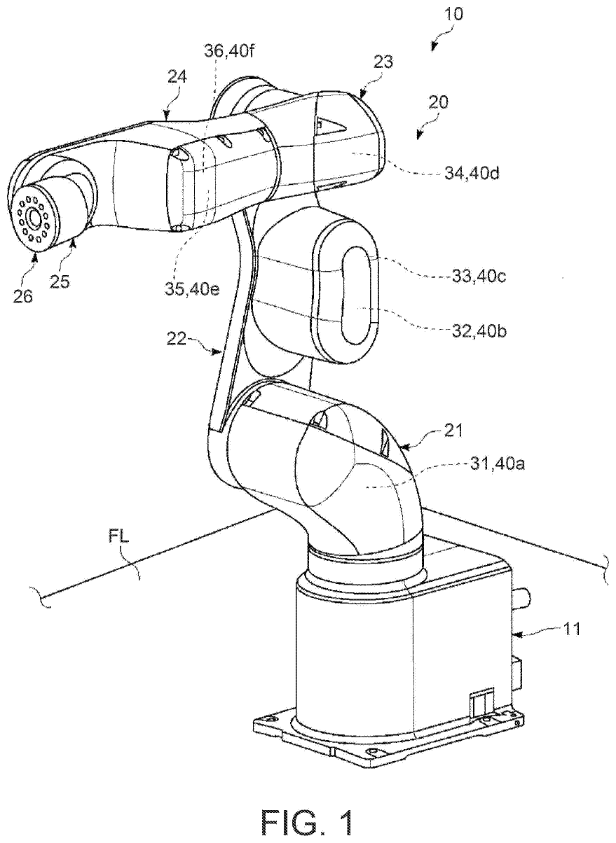

FIG. 1 is a diagram showing a schematic configuration of a robot 10. FIG. 1 is a diagram showing a perspective view of the robot 10. The robot 10 shown in FIG. 1 is used for carrying, assembling, inspecting, and the like of various workpieces.

The robot 10 includes a base 11, a robot arm 20, a first drive section 31, a second drive section 32, a third drive section 33, a fourth drive section 34, a fifth drive section 35, and a sixth drive section 36.

The base 11 is placed on a horizontal floor FL. The base 11 may be placed not on the floor FL but on a wall, a ceiling, a frame, or the like. The base 11 accommodates a power supply unit 70, a control unit 100, and the like (to be described later).

The robot arm 20 includes a plurality of arms. The robot arm 20 shown in FIG. 1 includes a first arm 21, a second arm 22, a third arm 23, a fourth arm 24, a fifth arm 25, and a sixth arm 26 as the plurality of arms. An end effector (not shown) is detachably and attachably attached to the tip end of the sixth arm 26.

The end effector is not particularly limited, but is constituted by a hand that grips the workpiece, an attraction head that attracts the workpiece, and the like. The workpiece is not particularly limited. The workpiece is an electronic component, an electronic apparatus, or the like.

The robot 10 is a single-arm six axes vertical articulated robot in which the base 11 and the plurality of arms of the robot arm 20 are coupled in the order of base 11, the first arm 21, the second arm 22, the third arm 23, the fourth arm 24, the fifth arm 25, and the sixth arm 26.

The lengths of the first arm 21, the second arm 22, the third arm 23, the fourth arm 24, the fifth arm 25, and the sixth arm 26 are not particularly limited, and can be appropriately set. The number of arms included in the robot arm 20 may be five or less or seven or more. The robot 10 may be a scalar robot or a dual-arm robot having two or more robot arms 20.

The first drive section 31 is disposed on the first arm 21. The first drive section 31 rotates the first arm 21 with respect to the base 11. The first drive section 31 includes a first motor unit 40a and a decelerator (not shown). The first motor unit 40a is an example of the motor unit 40. The first motor unit 40a generates thrust for rotating the first arm 21.

The second drive section 32 is disposed on the second arm 22. The second drive section 32 rotates the second arm 22 with respect to the first arm 21. The second drive section 32 includes a second motor unit 40b and a decelerator (not shown). The second motor unit 40b is an example of the motor unit 40. The second motor unit 40b generates a thrust for rotating the second arm 22.

The third drive section 33 is disposed on the second arm 22. The third drive section 33 rotates the third arm 23 with respect to the second arm 22. The third drive section 33 includes a third motor unit 40c and a decelerator (not shown). The third motor unit 40c is an example of the motor unit 40. The third motor unit 40c generates a thrust for rotating the third arm 23.

The fourth drive section 34 is disposed on the third arm 23. The fourth drive section 34 rotates the fourth arm 24 with respect to the third arm 23. The fourth drive section 34 includes a fourth motor unit 40d and a decelerator (not shown). The fourth motor unit 40d is an example of the motor unit 40. The fourth motor unit 40d generates a thrust for rotating the fourth arm 24.

The fifth drive section 35 is disposed on the fourth arm 24. The fifth drive section 35 rotates the fifth arm 25 with respect to the fourth arm 24. The fifth drive section 35 includes a fifth motor unit 40e and a decelerator (not shown). The fifth motor unit 40e is an example of the motor unit 40. The fifth motor unit 40e generates a thrust for rotating the fifth arm 25.

The sixth drive section 36 is disposed on the fourth arm 24. The sixth drive section 36 rotates the sixth arm 26 with respect to the fifth arm 25. The sixth drive section 36 includes a sixth motor unit 40f and a decelerator (not shown). The sixth motor unit 40f is an example of the motor unit 40. The sixth motor unit 40f generates a thrust for rotating the sixth arm 26.

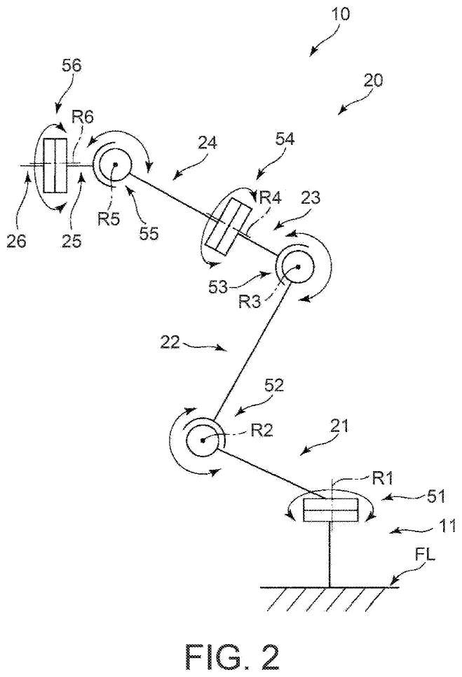

FIG. 2 schematically shows the robot 10. FIG. 2 schematically shows the robot 10 shown in FIG. 1. FIG. 2 shows a first joint 51, a second joint 52, a third joint 53, a fourth joint 54, a fifth joint 55, and a sixth joint 56.

The base 11 and the first arm 21 are connected via the first joint 51. The first arm 21 is configured to be pivotable with respect to the base 11 around a first pivot axis R1 parallel to the vertical axis. The vertical axis is an axis perpendicular to the floor FL. The first arm 21 is driven by the first drive section 31 to pivot around the first pivot axis R1.

The first arm 21 and the second arm 22 are coupled via the second joint 52. The second arm 22 is configured to be pivotable with respect to the first arm 21 around a second pivot axis R2 parallel to the floor FL. The second arm 22 is driven by the second drive section 32 to pivot around the second pivot axis R2.

The second arm 22 and the third arm 23 are coupled via the third joint 53. The third arm 23 is configured to be pivotable with respect to the second arm 22 around a third pivot axis R3 parallel to the floor FL. The third arm 23 is driven by the third drive section 33 to pivot around the third pivot axis R3.

The third arm 23 and the fourth arm 24 are coupled via the fourth joint 54. The fourth arm 24 is configured to be pivotable with respect to the third arm 23 around a fourth pivot axis R4 parallel to a central axis of the third arm 23. The fourth arm 24 is driven by the fourth drive section 34 to pivot around the fourth pivot axis R4.

The fourth arm 24 and the fifth arm 25 are coupled via the fifth joint 55. The fifth arm 25 is configured to be pivotable with respect to the fourth arm 24 around a fifth pivot axis R5 orthogonal to a central axis of the fourth arm 24. The fifth arm 25 is driven by the fifth drive section 35 to pivot around the fifth pivot axis R5.

The fifth arm 25 and the sixth arm 26 are coupled via the sixth joint 56. The sixth arm 26 is configured to be pivotable with respect to the fifth arm 25 around a sixth pivot axis R6 parallel to a central axis of the tip end portion of the fifth arm 25. The sixth arm 26 is driven by the sixth drive section 36 to pivot around the sixth pivot axis R6.

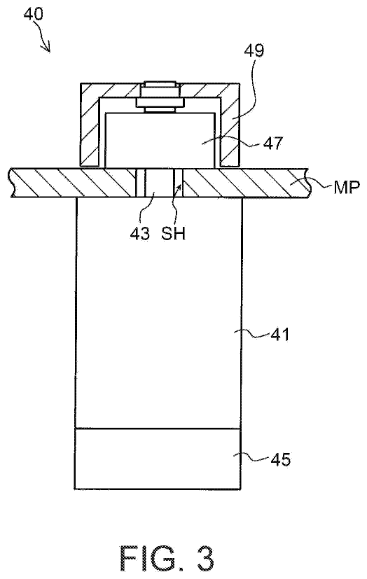

FIG. 3 shows a schematic configuration of the motor unit 40. The motor unit 40 includes a motor 41, an encoder 45, a brake 47, and a pulley 49. The motor unit 40 is supported by a motor plate MP. As an example, the motor unit 40 is constituted by a servo motor having a rotary encoder.

The motor plate MP is a member that fixes the motor unit 40 to the robot 10. The motor unit 40 is fixed to the robot 10 via a motor plate MP. The motor plate MP may be a member constituting an arm or the like. Since the motor plate MP forms a part of the arm, the motor unit 40 is directly fixed to the robot 10. A motor 41 and the brake 47 are fixed to the motor plate MP. The motor plate MP includes a shaft hole SH.

The motor 41 generates a driving force for rotating the arm. The motor 41 has an output shaft 43. The motor 41 is supplied with electric power and generates a rotational output of the output shaft 43. The motor 41 generates electric power by receiving the supply of a rotational force to the output shaft 43. The motor 41 is fixed to the motor plate MP. The output shaft 43 passes through a shaft hole SH of the motor plate MP. The output shaft 43 corresponds to an example of a rotation shaft.

The pulley 49 is connected to the output shaft 43 of the motor 41 via a decelerator. The pulley 49 is rotated by the output shaft 43 of the motor 41. The pulley 49 rotates the arm by transmitting a driving force to the arm via a belt. The pulley 49 is transmitted with the rotational force caused by the rotation of the arm in a state where electric power is not supplied to the motor 41. The pulley 49 supplies the rotational force caused by the rotation of the arm to the output shaft 43.

The encoder 45 detects a rotational position of the output shaft 43 of the motor 41. The encoder 45 may calculate a rotational velocity of the output shaft 43 using the detected the rotational position. The encoder 45 outputs the rotational position or the rotational velocity to the control unit 100 or the like as an encoder signal ES. The encoder signal ES indicates the operation of the motor 41. The encoder signal ES corresponds to an example of an output signal. The encoder 45 is fixed to the motor 41 on the side opposite the motor plate MP with respect to the motor 41.

The brake 47 is fixed to the motor plate MP on the side that is opposite that of the motor 41 with respect to the motor plate MP. The brake 47 is constituted by a mechanical brake, an electromagnetic brake, a hydraulic brake, or the like. Desirably, the brake 47 is an electromagnetic brake. The electromagnetic brake holds the output shaft 43 non-rotatably in a state where electric power is not supplied. The electromagnetic brake has an elastic member, such as a spring, and a movable member. An elastic member presses the movable member against a connecting member connected to the output shaft 43. The output shaft 43 is non-rotatably held by the frictional force between the connecting member and the movable member. The electromagnetic brake allows the output shaft 43 to be rotatable in a state in which electric power is supplied. When electric power is supplied, the electromagnetic brake separates the movable member from the connecting member against the elastic member. When the movable member is separated from the connecting member, the output shaft 43 becomes rotatable. The movable member may press the output shaft 43 instead of the connecting member.

The motor unit 40 may have a torque limiter (not shown). When an overload is applied to the output shaft 43 of the motor 41, the torque limiter shuts off the load applied to the output shaft 43. The torque limiter is used when the robot 10 performs a torque control.

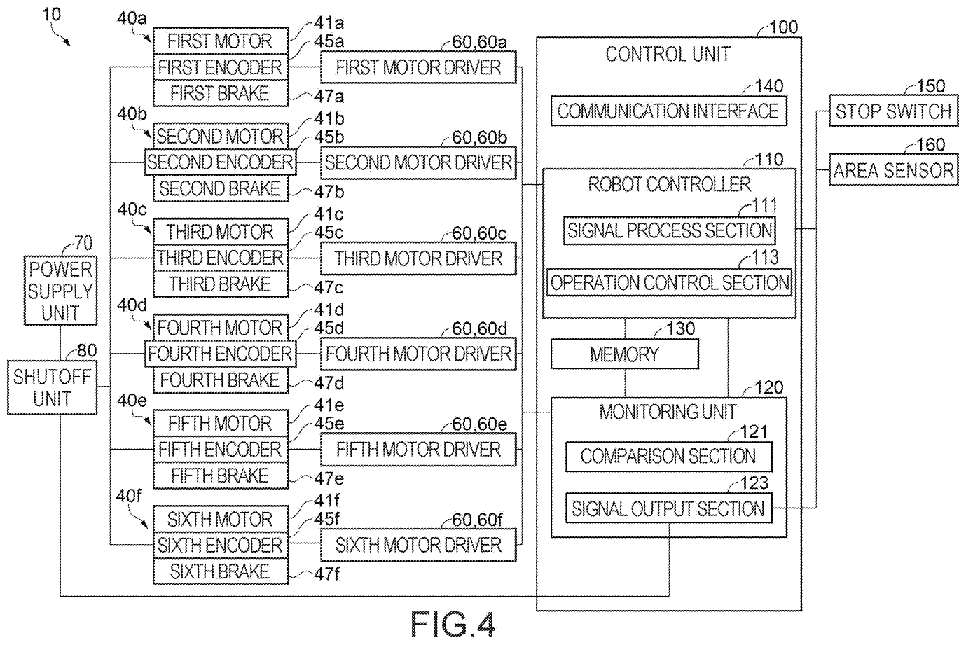

FIG. 4 shows a block configuration of the robot 10. FIG. 4 shows a configuration related to the operation of the robot arm 20. The robot 10 includes the plurality of motor units 40, a plurality of motor drivers 60, the power supply unit 70, a shutoff unit 80, the control unit 100, a stop switch 150, and an area sensor 160. In FIG. 4, a unit for operating the end effector is omitted.

Each of the plurality of motor units 40 rotates the arm. FIG. 4 shows the first motor unit 40a, the second motor unit 40b, the third motor unit 40c, the fourth motor unit 40d, the fifth motor unit 40e, and the sixth motor unit 40f as the plurality of motor units 40.

The first motor unit 40a includes a first motor 41a, a first encoder 45a, and a first brake 47a. The first motor 41a is an example of the motor 41. The first encoder 45a is an example of the encoder 45. The first encoder 45a outputs the rotational position or rotation angle of the output shaft 43 of the first motor 41a as the encoder signal ES. The first brake 47a is an example of the brake 47.

The second motor unit 40b includes a second motor 41b, a second encoder 45b, and a second brake 47b. The second motor 41b is an example of the motor 41. The second encoder 45b is an example of the encoder 45. The second encoder 45b outputs the rotational position or rotation angle of the output shaft 43 of the second motor 41b as the encoder signal ES. The second brake 47b is an example of the brake 47.

The third motor unit 40c includes a third motor 41c, a third encoder 45c, and a third brake 47c. The third motor 41c is an example of the motor 41. The third encoder 45c is an example of the encoder 45. The third encoder 45c outputs the rotational position or rotation angle of the output shaft 43 of the third motor 41c as the encoder signal ES. The third brake 47c is an example of the brake 47.

The fourth motor unit 40d includes a fourth motor 41d, a fourth encoder 45d, and a fourth brake 47d. The fourth motor 41d is an example of the motor 41. The fourth encoder 45d is an example of the encoder 45. The fourth encoder 45d outputs the rotational position or rotation angle of the output shaft 43 of the fourth motor 41d as the encoder signal ES. The fourth brake 47d is an example of the brake 47.

The fifth motor unit 40e includes a fifth motor 41e, a fifth encoder 45e, and a fifth brake 47e. The fifth motor 41e is an example of the motor 41. The fifth encoder 45e is an example of the encoder 45. The fifth encoder 45e outputs the rotational position or rotation angle of the output shaft 43 of the fifth motor 41e as the encoder signal ES. The fifth brake 47e is an example of the brake 47.

The sixth motor unit 40f includes a sixth motor 41f, a sixth encoder 45f, and a sixth brake 47f. The sixth motor 41f is an example of the motor 41. The sixth encoder 45f is an example of the encoder 45. The sixth encoder 45f outputs the rotational position or rotation angle of the output shaft 43 of the sixth motor 41f as the encoder signal ES. The sixth brake 47f is an example of the brake 47.

Each of the plurality of motor drivers 60 is connected to the motor unit 40. The motor driver 60 controls the operation of the motor unit 40 by transmitting a driver signal MS to the motor unit 40. The motor driver 60 generates the driver signal MS based on a control signal CS transmitted from the control unit 100. The motor driver 60 generates a driver signal MS corresponding to the motor unit 40. The driver signal MS may be the same control value as the control signal CS, or may be a control value obtained by converting the control signal CS. When the control unit 100 causes the motor 41 to execute a predetermined operation, the motor driver 60 may generate the driver signal MS obtained by converting the control signal CS. The motor driver 60 receives the encoder signal ES output from the motor unit 40.

The plurality of motor drivers 60 include a first motor driver 60a, a second motor driver 60b, a third motor driver 60c, a fourth motor driver 60d, a fifth motor driver 60e, and a sixth motor driver 60f.

The first motor driver 60a controls the first motor unit 40a. The first motor driver 60a control the operation of the first motor 41a and the first brake 47a by transmitting the driver signal MS to the first motor unit 40a. The first motor driver 60a receives the encoder signal ES output from the first encoder 45a. The first motor driver 60a transmits the encoder signal ES to the control unit 100 and the like.

The second motor driver 60b controls the second motor unit 40b. The second motor driver 60b controls the operation of the second motor 41b and the second brake 47b by transmitting the driver signal MS to the second motor unit 40b. The second motor driver 60b receives the encoder signal ES output from the second encoder 45b. The second motor driver 60b transmits the encoder signal ES to the control unit 100 and the like.

The third motor driver 60c controls the third motor unit 40c. The third motor driver 60c controls the operation of the third motor 41c and the third brake 47c by transmitting the driver signal MS to the third motor unit 40c. The third motor driver 60c receives the encoder signal ES output from the third encoder 45c. The third motor driver 60c transmits the encoder signal ES to the control unit 100 and the like.

The fourth motor driver 60d controls the fourth motor unit 40d. The fourth motor driver 60d controls the operations of the fourth motor 41d and the fourth brake 47d by transmitting the driver signal MS to the fourth motor unit 40d. The fourth motor driver 60d receives the encoder signal ES output from the fourth encoder 45d. The fourth motor driver 60d transmits the encoder signal ES to the control unit 100 and the like.

The fifth motor driver 60e controls the fifth motor unit 40e. The fifth motor driver 60e controls the operation of the fifth motor 41e and the fifth brake 47e by transmitting the driver signal MS to the fifth motor unit 40e. The fifth motor driver 60e receives the encoder signal ES output from the fifth encoder 45e. The fifth motor driver 60e transmits the encoder signal ES to the control unit 100 and the like.

The sixth motor driver 60f controls the sixth motor unit 40f. The sixth motor driver 60f controls the operation of the sixth motor 41f and the sixth brake 47f by transmitting the driver signal MS to the sixth motor unit 40f. The sixth motor driver 60f receives the encoder signal ES output from the sixth encoder 45f. The sixth motor driver 60f transmits the encoder signal ES to the control unit 100 and the like.

The power supply unit 70 supplies electric power from an external power supply to each unit. The power supply unit 70 supplies electric power to each motor unit 40, each motor driver 60, the control unit 100, and the like. The power supply unit 70 supplies electric power to each motor unit 40 via the shutoff unit 80. In FIG. 4, some power supply paths such as a path for supplying electric power from the power supply unit 70 to the control unit 100 are not shown.

The shutoff unit 80 supplies or shuts off the electric power from the external power supply to the motor unit 40 including the motor 41. The shutoff unit 80 is constituted by a switch, a relay, a contactor, and the like. The shutoff unit 80 is desirably constituted by the relay. Since the shutoff unit 80 is constituted by the relay, it is possible to control on/off of a large current with a small current. The shutoff unit 80 is provided in the power supply path between the power supply unit 70 and the motor unit 40. When the robot 10 operates, the shutoff unit 80 supplies electric power from the power supply unit 70 to each motor unit 40. When a monitoring unit 120 of the control unit 100 sends a shutoff signal DS to the shutoff unit 80, the shutoff unit 80 shuts off the electric power to each motor unit 40. The shutoff unit 80 shuts off the electric power to the motor unit 40, thereby causing the motor 41 to stop in an uncontrolled state. When the motor 41 stops uncontrolled, the stop position of the arm becomes indefinite.

The control unit 100 controls each unit of the robot 10. The control unit 100 controls the operation of each unit by transmitting various signals to each unit. The control unit 100 is, as an example, a processor circuit having a central processing unit (CPU). The control unit 100 is constituted by one or more processor circuits. The control unit 100 functions as a robot controller 110 and the monitoring unit 120. The control unit 100 may function as a functional section different from the robot controller 110 and the monitoring unit 120. The control unit 100 includes a memory 130 and a communication interface 140.

The control unit 100 functions as a robot controller 110 by executing a robot control program. The control unit 100 functions as the monitoring unit 120 by executing a monitoring program. The robot controller 110 and the monitoring unit 120 may function on the same processor or on different processors. The robot controller 110 and the monitoring unit 120 function independently of each other.

The robot controller 110 controls the operation of the robot arm 20. The robot controller 110 transmits the control signal CS to the motor driver 60 at a predetermined timing. The robot controller 110 controls the operation of each motor unit 40 having the motor 41 by outputting the control signal CS to the motor driver 60. The control signal CS is a signal for instructing the rotational position or rotational velocity of the output shaft 43 of the motor 41. The robot controller 110 controls the operation of each arm by controlling the operation of each motor unit 40.

The robot controller 110 receives the encoder signal ES output from the encoder 45 via each motor driver 60. The robot controller 110 receives the encoder signal ES indicating the operation of the motor 41 based on the control signal CS. The robot controller 110 performs various kinds of control using the encoder signal ES.

The robot controller 110 receives various signals from the stop switch 150 and the like. The robot controller 110 generates an operation signal based on various signals. The robot controller 110 may transmit various signals to the motor driver 60 or the like as the operation signals. When causing the robot arm 20 to execute a predetermined operation, the robot controller 110 generates the operation signal. The robot controller 110 transmits the operation signal to the motor driver 60. The robot controller 110 performs various kinds of control by transmitting the operation signal to the motor driver 60.

The robot controller 110 functions as a signal process section 111 and an operation control section 113. The robot controller 110 corresponds to an example of a controller.

The signal process section 111 generates the operation signal corresponding to the operation of the robot arm 20. The signal process section 111 processes various signals output from the stop switch 150 and the like. The signal process section 111 receives various signals. The signal process section 111 generates the operation signal based on various signals. The signal process section 111 may use various signals as the operation signals. The signal process section 111 transmits the operation signal to the operation control section 113. The signal process section 111 may transmit the operation signal to the motor driver 60, the monitoring unit 120, and the like.

As an example, the signal process section 111 receives a stop signal SS output from the stop switch 150. The signal process section 111 transmits the stop signal SS as the operation signal to the operation control section 113. The stop signal SS corresponds to a stop operation of the robot arm 20 and the motor unit 40. The signal process section 111 receives an area error signal output from the area sensor 160. The signal process section 111 transmits the area error signal to the operation control section 113 as the operation signal. The area error signal corresponds to the stop operation or a deceleration operation of the robot arm 20 and the motor unit 40. The signal process section 111 may receive a discrimination signal output from a sensor or the like different from the stop switch 150 and the area sensor 160. The discrimination signal is, as an example, a trajectory correction operation for correcting the operations of the robot arm 20 and the motor unit 40. The signal process section 111 transmits the discrimination signal to the operation control section 113 or the like. The stop signal SS and the area error signal correspond to an example of the stop command.

The signal process section 111 generates the operation signal corresponding to the operation of the robot arm 20. The signal process section 111 transmits the operation signal to the motor driver 60. The signal process section 111 causes the motor unit 40 to execute motor control corresponding to the operation of the robot arm 20 by transmitting the operation signal. The signal process section 111 generates a the torque control signal TC, as an example, when the user causes the robot arm 20 to execute a placement operation of placing the workpiece at a predetermined position. The signal process section 111 transmits the torque control signal TC to the operation control section 113.

The operation control section 113 causes the motor unit 40 including the motor 41 to execute various operations. The operation control section 113 generates the series of control signals CS related to various operations. The operation control section 113 transmits the control signal CS to the motor driver 60 at a predetermined timing. The operation control section 113 causes the motor unit 40 to execute various operations by transmitting the control signal CS. As the motor unit 40 performs various operations, the robot arm 20 performs desired operations.

The operation control section 113 receives the operation signal. The operation control section 113 causes the motor unit 40 to execute various operations based on the operation signal. The operation control section 113 receives the operation signal from the signal process section 111. The operation control section 113 generates the series of control signals CS based on the operation signal. The operation control section 113 transmits the control signal CS to the motor driver 60 at a predetermined timing. The operation control section 113 causes the motor 41 to execute various operations by transmitting the control signal CS.

The operation control section 113 receives the stop signal SS or the area error signal as the operation signal. The operation control section 113 generates the series of control signals CS based on the stop signal SS or the area error signal. The generated control signal CS is a signal for executing the stop operation for stopping the motor 41. The stop operation corresponds to an example of a predetermined operation. The operation control section 113 transmits the control signal CS to the motor driver 60 at a predetermined timing. The operation control section 113 causes the motor 41 to execute the stop operation by transmitting the control signal CS to the motor driver 60.

The operation control section 113 receives the torque control signal TC as the operation signal. The operation control section 113 generates the series of control signals CS based on the torque control signal TC. The generated control signal CS is a signal for causing the motor 41 to execute a torque control operation. The torque control operation corresponds to an example of a predetermined operation. The operation control section 113 transmits the control signal CS to the motor driver 60 at a predetermined timing. The operation control section 113 causes the motor 41 to execute the torque control operation by transmitting the control signal CS to the motor driver 60. The operation control section 113 may cause the motor 41 to execute an operation different from the stop operation and the torque control operation. The operation control section 113 causes the motor 41 to execute, as an example, the deceleration operation, a trajectory correction operation, and the like. The deceleration operation, the trajectory correction operation, and the like correspond to an example of a predetermined operation.

The operation control section 113 receives the encoder signal ES output from each encoder 45. The operation control section 113 may adjust the control signal CS using the encoder signal ES. The operation control section 113 uses, as an example, the encoder signal ES as a feedback signal.

The monitoring unit 120 monitors the operation of each motor unit 40 having the motor 41. The monitoring unit 120 detects an operating abnormally of the motor 41 by monitoring the operation of the motor unit 40. When the monitoring unit 120 detects an operating abnormally of the motor 41, it outputs the shutoff signal DS. The monitoring unit 120 functions as a comparison section 121 and a signal output section 123. The monitoring unit 120 corresponds to an example of a monitoring section.

The comparison section 121 compares the control signal CS with the encoder signal ES. The comparison section 121 receives the control signal CS and the encoder signal ES at a predetermined timing. The comparison section 121 receives the control signal CS output by the operation control section 113 of the robot controller 110. The comparison section 121 receives the encoder signal ES output by the encoder 45 of each motor unit 40. The encoder signal ES is the rotational position or the rotation angle of the output shaft 43. When receiving the control signal CS and the encoder signal ES, the comparison section 121 calculates the difference between the control signal CS and the encoder signal ES as the absolute value. The comparison section 121 compares the difference with an allowable value. The allowable value is a predetermined value. The allowable value corresponds to an example of a threshold. When determining that the difference is smaller than the allowable value, the comparison section 121 judges that the motor 41 is operating normally. When determining that the difference is larger than the allowable value, the comparison section 121 judges that the motor 41 is operating abnormally. When determining that the difference is larger than the allowable value, the comparison section 121 generates a n operation failure signal. The comparison section 121 transmits the operation failure signal to the signal output section 123.

The signal output section 123 outputs various signals to the shutoff unit 80 and the like. The signal output section 123 receives the operation failure signal transmitted by the comparison section 121. The signal output section 123 outputs the shutoff signal DS to the shutoff unit 80. The signal output section 123 may transmit the operation failure signal to each motor driver 60, the signal process section 111, and the like. The signal output section 123 may receive the operation signal output from the signal process section 111.

The shutoff signal DS is a signal for executing the STO function. The STO is an abbreviation for Safe Torque Off. The STO function is a function of electrically shut off the drive energy to the motor 41 of the robot 10. The signal output section 123 outputs the shutoff signal DS to the shutoff unit 80, thereby shutting off the electric power to the motor unit 40 including the motor 41. When the shutoff signal DS is received, the shutoff unit 80 may shut off the electric power to the motor driver 60, the control unit 100, and the like. The shutoff signal DS corresponds to an example of a power shutoff command.

The memory 130 stores various data and the like. The memory 130 is constituted by a semiconductor memory such as a read only memory (ROM) or a random access memory (RAM). The memory 130 stores the robot control program executed by the control unit 100 and the monitoring program. The memory 130 stores various kinds of control data used in the robot controller 110. The memory 130 stores monitoring data such as the allowable value used in the comparison section 121. The memory 130 stores an evaluation value calculated by the comparison section 121, a comparison result, and the like as the history data.

The communication interface 140 is an interface circuit for communication connection with an external device. The communication interface 140 is connected to the external device in a wired or wireless manner in accordance with a predetermined communication protocol. The communication interface 140 is constituted by a wired connector or a wireless communication port. The wired connector is a universal serial bus (USB) connector, a local area network (LAN) connector, or the like. The wireless communication port is a Wi-Fi communication port, an Bluetooth communication port, or the like. Wi-Fi and Bluetooth are registered trademarks. The communication interface 140 receives various control data from the external device. The communication interface 140 transmits the history data and the like to the external device.

The stop switch 150 is operated by the user of the robot 10. The stop switch 150 is wired or wirelessly connected to the control unit 100. As an example, when the robot arm 20 executes an unexpected operation, the user manually performs the input operation on the stop switch 150. When the input operation is performed, the stop switch 150 outputs the stop signal SS to the signal process section 111 of the control unit 100.

The area sensor 160 detects whether or not the robot arm 20 is positioned within a predetermined operation range. When detecting that the robot arm 20 is positioned outside the predetermined operation range, the area sensor 160 outputs the area error signal to the signal process section 111.

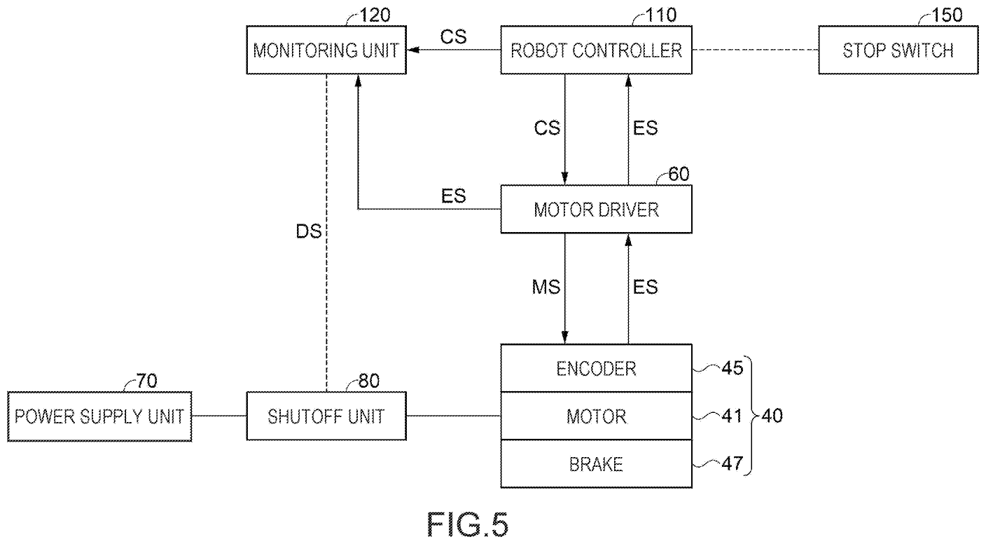

FIG. 5 schematically shows a block configuration of the robot 10. FIG. 5 shows a state where the robot controller 110 is controlling the motor unit 40. FIG. 5 shows the flow of each signal and the electric power supply state. The plurality of motor units 40 are controlled based on the flow the signals shown in FIG. 5. In FIG. 5, the area sensor 160 is omitted.

When operating the motor unit 40, the robot controller 110 generates a control signal group including the series of control signals CS. The robot controller 110 transmits the control signal CS included in the control signal group to the motor driver 60 at a predetermined timing. The control signal CS includes, as an example, a controller control value instructing the rotational velocity of the output shaft 43 of the motor 41. When the robot controller 110 transmits the control signal CS to the motor driver 60, it transmits the control signal CS to the monitoring unit 120.

The motor driver 60 receives the control signal CS. The motor driver 60 generates the driver signal MS corresponding to the control signal CS. The driver signal MS is a signal that can be processed by the motor unit 40. If the motor unit 40 can process the control signal CS, the motor driver 60 may transmit the control signal CS to the motor unit 40 as the driver signal MS.

The motor unit 40 receives the driver signal MS. The motor 41 included in the motor unit 40 rotates the output shaft 43 based on the driver signal MS. The encoder 45 detects the rotational velocity of the output shaft 43 rotating based on the driver signal MS as an encoder output value. The motor unit 40 transmits the encoder signal ES including the encoder output value to the motor driver 60. The motor unit 40 may transmit the encoder signal ES to the monitoring unit 120.

The motor driver 60 receives the encoder signal ES including the encoder output value. The received encoder signal ES is a signal based on the control signal CS. The motor driver 60 transmits the encoder signal ES to the robot controller 110 and the monitoring unit 120. When the motor unit 40 directly transmits the encoder signal ES to the monitoring unit 120, the motor driver 60 may not transmit the encoder signal ES to the monitoring unit 120.

The robot controller 110 receives the encoder signal ES. The robot controller 110 may adjust the controller control value by using the encoder output value included in the encoder signal ES. The robot controller 110 adjusts the controller control value included in the control signal CS to be transmitted next by using the encoder output value. The robot controller 110 transmits the control signal CS including the adjusted controller control value to the motor driver 60. The robot controller 110 may consecutively transmit the control signal CS including the controller control value, which is not adjusted by the encoder output value, to the motor driver 60.

The monitoring unit 120 receives the control signal CS and the encoder signal ES based on the control signal CS. The monitoring unit 120 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80.

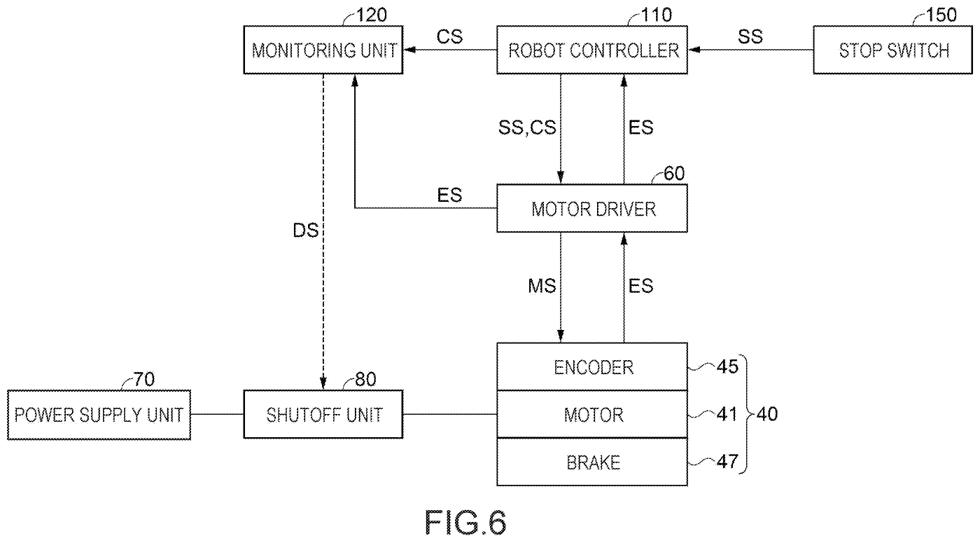

FIG. 6 schematically shows a block configuration of the robot 10. FIG. 6 shows a state when the stop switch 150 outputs the stop signal SS. FIG. 6 shows the flow of each signal and the electric power supply state. The plurality of motor units 40 are controlled based on the flow of signals shown in FIG. 6. In FIG. 6, the area sensor 160 is omitted.

When the user performs the input operation to the stop switch 150, the stop switch 150 outputs the stop signal SS. The stop switch 150 outputs the stop signal SS to the robot controller 110.

The robot controller 110 receives the stop signal SS. The robot controller 110 transmits the stop signal SS to the motor driver 60. The robot controller 110 generates the control signal group that causes the stop operation of the motor 41 based on the stop signal SS. The robot controller 110 transmits the control signal CS included in the control signal group to the motor driver 60 at a predetermined timing.

The motor driver 60 receives the stop signal SS and control signal CS causes the motor 41 to stop operation. When the stop signal SS is received, the motor driver 60 generates the driver signal MS causes the motor 41 to the stop operation. The driver signal MS includes a driver control value. The driver control value is a value for instructing the rotational velocity of the output shaft 43 of the motor 41. The driver control value corresponds to the controller control value. By using the driver signal MS causes the motor 41 to stop operation, the motor driver 60 can stop the motor 41 faster than when the control signal CS is used. Instead of transmitting the control signal CS, which causes the motor 41 to stop operation, the motor driver 60 transmits the driver signal MS, which causes the motor 41 to stop operation, to the motor unit 40.

The motor driver 60 may transmit the control signal CS to the motor unit 40 as the driver signal MS. When transmitting the control signal CS to the motor unit 40, the motor driver 60 may include and transmit a brake actuation signal for actuating the brake 47 in the driver signal MS.

The motor unit 40 receives the driver signal MS. The motor 41 performs the stop operation based on the driver signal MS. The encoder 45 detects the rotational velocity of the output shaft 43 while the motor 41 is performing the stop operation as the encoder output value. The motor unit 40 transmits the encoder signal ES including the encoder output value to the motor driver 60. When the brake actuation signal is included in the driver signal MS, the motor unit 40 actuates the brake 47. The motor unit 40 may transmit the encoder signal ES directly to the monitoring unit 120.

The motor driver 60 receives the encoder signal ES. The encoder signal ES is associated with the control signal CS. The motor driver 60 transmits the encoder signal ES to the robot controller 110 and the monitoring unit 120. When the motor unit 40 directly transmits the encoder signal ES to the monitoring unit 120, the motor driver 60 may not transmit the encoder signal ES to the monitoring unit 120.

The monitoring unit 120 receives the control signal CS and the encoder signal ES based on the control signal CS. The monitoring unit 120 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80.

The robot controller 110 receives the encoder signal ES corresponding to the control signal CS. The robot controller 110 compares the control signal CS with the encoder signal ES. The monitoring unit 120 compares the controller control value included in the control signal CS with the encoder output value included in the encoder signal ES. The robot controller 110 calculates the difference between the controller control value and the encoder output value as an evaluation value.

The robot controller 110 reads out the allowable value stored in the memory 130. The robot controller 110 determines a control allowable value based on the allowable value. The control allowable value may be stored in the memory 130 in advance. If the control allowable value is stored in the memory 130, the robot controller 110 reads the control allowable value from the memory 130. The robot controller 110 temporarily stores the control allowable value. The control allowable value is a value smaller than the allowable value. The control allowable value corresponds to an example of a second threshold.

The robot controller 110 compares the evaluation value with the control allowable value. When the evaluation value is smaller than the control allowable value, the robot controller 110 continues the stop operation of the motor 41 by using the control signal CS included in the control signal group. When the evaluation value is larger than the control allowable value, the robot controller 110 corrects the control signal CS and generates the modified control signal MCS.

The modified control signal MCS includes a modified controller control value. The modified control signal MCS is a signal that causes the motor 41 to stop operation. As an example, the robot controller 110 generates the modified control signal MCS in which the encoder output value received immediately before the generation of the modified control signal MCS is set as the modified controller control value.

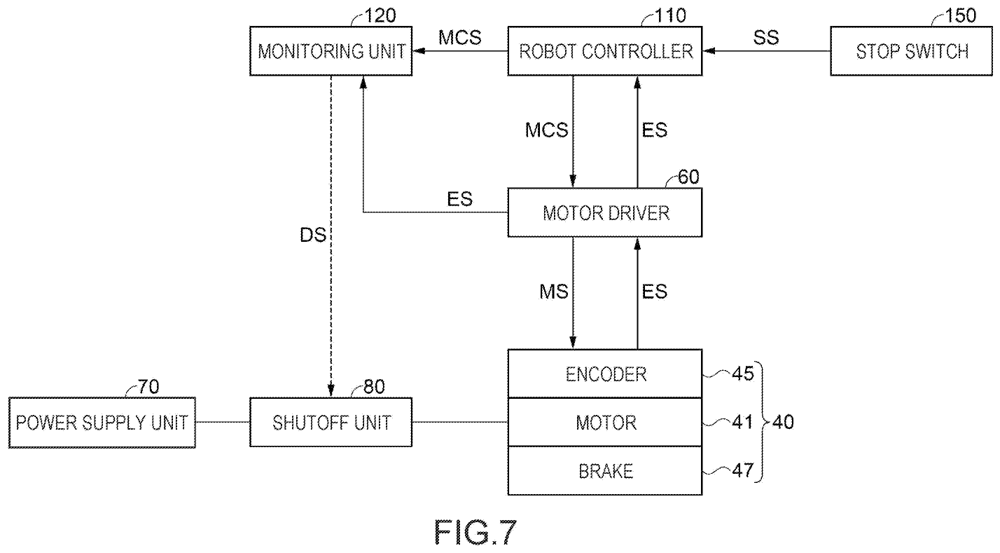

FIG. 7 schematically shows a block configuration of the robot 10. FIG. 7 shows a state when the robot controller 110 generates the modified control signal MCS. FIG. 7 shows the flow of signals and the electric power supply state. The plurality of motor units 40 are controlled based on the flow of signals shown in FIG. 7. In FIG. 7, the area sensor 160 is omitted.

The robot controller 110 transmits the modified control signal MCS including the modified controller control value to the motor driver 60 at a predetermined timing. The robot controller 110 transmits the modified control signal MCS to the monitoring unit 120.

The motor driver 60 receives the modified control signal MCS. When receiving the modified control signal MCS, the motor driver 60 transmits the driver signal MS, which causes the motor 41 to stop operation, to the motor unit 40. The motor driver 60 may or may not modify the driver signal MS based on the modified control signal MCS. The motor driver 60 transmits the driver signal MS corresponding to the modified control signal MCS to the motor unit 40.

The motor driver 60 may transmit the modified control signal MCS to the motor unit 40 as the driver signal MS. When transmitting the driver signal MS to the motor unit 40, the motor driver 60 may include and transmit a brake actuation signal for actuating the brake 47 in the driver signal MS.

The motor unit 40 receives the driver signal MS. The motor 41 performs the stop operation based on the driver signal MS. The encoder 45 detects the rotational velocity of the output shaft 43 while the motor 41 is performing the stop operation as the encoder output value. The motor unit 40 transmits the encoder signal ES including the encoder output value to the motor driver 60. When the brake actuation signal is included in the driver signal MS, the motor unit 40 actuates the brake 47. The motor unit 40 may transmit the encoder signal ES directly to the monitoring unit 120.

The motor driver 60 receives the encoder signal ES. The encoder signal ES is associated with the modified control signal MCS. The motor driver 60 transmits the encoder signal ES to the robot controller 110 and the monitoring unit 120. When the motor unit 40 directly transmits the encoder signal ES to the monitoring unit 120, the motor driver 60 may not transmit the encoder signal ES to the monitoring unit 120.

The monitoring unit 120 receives the modified control signal MCS and the encoder signal ES based on the modified control signal MCS. The monitoring unit 120 compares the modified control signal MCS with the encoder signal ES. The monitoring unit 120 compares the modified controller control value included in the modified control signal MCS with the encoder output value included in the encoder signal ES. The monitoring unit 120 calculates the difference between the controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80. The modified control signal MCS corresponds to an example of a second control signal, and the monitoring unit 120 comparing the difference with the allowable value corresponds to an example of comparing the difference between the second control signal and the output signal with the threshold.

The modified controller control value included in the modified control signal MCS is the encoder output value received last time. The possibility that the difference between the modified controller control value and the encoder output value based on the modified controller control value is smaller than the allowable value increases. The possibility that the monitoring unit 120 outputs the shutoff signal DS is reduced. By controlling the motor unit 40, the robot controller 110 can cause the motor 41 to perform the stop operation.

The robot controller 110 receives the encoder signal ES corresponding to the modified control signal MCS. The robot controller 110 acquires the encoder output value included in the encoder signal ES. The robot controller 110 generates the modified control signal MCS in which the acquired encoder output value as the modified controller control value. The robot controller 110 generates the modified control signal MCS including the encoder output value as the modified controller control value every time the encoder signal ES is received. The robot controller 110 stops the motor 41 by transmitting the modified control signal MCS to the motor driver 60.

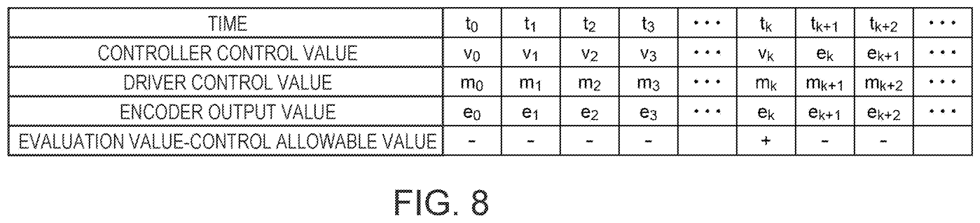

FIG. 8 shows controller control values and the like that are output at predetermined timings. FIG. 8 shows the controller control values and the like when the motor 41 is caused to execute the stop operation. FIG. 8 shows a case where the stop signal SS is received immediately before the timing t0. The controller control value is included in the control signal CS. The driver control value is a control value included in the driver signal MS, which is output to the motor unit 40 when the motor driver 60 receives the control signal CS at each time. The encoder output value is a detection value output from the encoder 45 in response to the control signal CS including the controller control value. “EVALUATION VALUE-CONTROL ALLOWABLE VALUE” indicates the result of subtracting the control allowable value from the evaluation value at each time. “−” indicates that the evaluation value is smaller than the control allowable value. “+” indicates that the evaluation value is larger than the control allowable value.

When receiving the stop signal SS, the robot controller 110 generates the control signal group for causing the motor 41 to execute the stop operation. The robot controller 110 generates, as an example, the control signal group from the timing t0 to the timing tn. The control signal group is an n+1 data group for stopping the motor 41 at the timing tn. Here, n is an integer.

At the timing to, the robot controller 110 transmits to the motor driver 60 the control signal CS in which the controller control value is v0 and the stop signal SS. v0 is an instruction value with respect to the rotational velocity of the output shaft 43 of the motor 41. In FIG. 8, the controller control value indicates the instruction value of the rotational velocity.

The motor driver 60 receives the control signal CS in which the controller control value is v0 and the stop signal SS. When the stop signal SS is received, the motor driver 60 generates the driver signal MS for causing the motor 41 to execute the stop operation. The motor driver 60 may generate a series of driver signal groups for causing the motor 41 to execute the stop operation. The motor driver 60 may generate the driver signal MS when receiving the control signal CS. The driver signal MS includes a driver output value. When the motor driver 60 receives the control signal CS in which the controller control value is v0 the motor driver 60 transmits a driver signal MS in which the driver control value is m0 to the motor unit 40. m0 is an instruction value with respect to the rotational velocity of the output shaft 43 of the motor 41. m0 is a value equal to v0 or larger than v0.

The motor unit 40 receives the driver signal MS in which the driver control value is m0. The motor 41 decelerates the rotational velocity of the output shaft 43 toward m0 based on the driver signal MS. After the motor 41 decelerates, the encoder 45 detects the rotational velocity of the output shaft 43. The encoder 45 detects that the encoder output value is e0. The motor unit 40 outputs the encoder signal ES in which the encoder output value is e0 to the motor driver 60.

The motor driver 60 receives the encoder signal ES in which the encoder output value is e0. The motor driver 60 transmits the encoder signal ES to the robot controller 110 and the monitoring unit 120.

The robot controller 110 receives the encoder signal ES in which the encoder output value is e0. The robot controller 110 calculates the absolute value of the difference between v0 and e0 as the evaluation value. The robot controller 110 calculates a value obtained by subtracting the control allowable value from the evaluation value. The value obtained by subtracting the control allowable value from the evaluation value at the timing t0 is a −value. The evaluation value is smaller than the control allowable value. The robot controller 110 transmits the control signal CS included in the control signal group to the motor driver 60 at the timing t1. The control signal CS transmitted at the timing t1 is a signal in which the controller control value is v1. The robot controller 110 transmits the control signal CS at a predetermined timing and receives the encoder signal ES corresponding to the control signal CS from the motor driver 60.

The monitoring unit 120 receives the control signal CS in which the controller control value is v0 and the encoder signal ES in which the encoder output value is e0. The monitoring unit 120 calculates the absolute value of the difference between v0 and e0 as the difference. The monitoring unit 120 compares the difference with the allowable value. The difference at the timing t0 is smaller than the control allowable value. The difference at the timing t0 is smaller than the allowable value. The monitoring unit 120 does not transmit the shutoff signal DS to the shutoff unit 80. The robot controller 110 can cause the motor 41 to execute the stop operation based on the control signal CS.

The robot controller 110 transmits the control signal CS in which the controller control value is vk to the motor driver 60 at the timing tk. k is an integer smaller than n. The control signal CS in which the controller control value is vk corresponds to an example of the first control signal. The motor driver 60 receives the control signal CS in which the controller control value is vk. The motor driver 60 transmits the driver signal MS corresponding to the control signal CS to the motor unit 40. The driver control value included in the driver signal MS is mk. The motor unit 40 receives the driver signal MS. The motor 41 decelerates the output shaft 43 based on the driver signal MS. When the motor 41 decelerates, the encoder 45 detects the rotational velocity of the output shaft 43. The motor unit 40 transmits the encoder signal ES in which the encoder output value is ek to the motor driver 60. The motor driver 60 transmits the encoder signal ES in which the encoder output value is ek to the robot controller 110 and the monitoring unit 120. The encoder signal ES in which the encoder output value is ek corresponds to an example of the first output signal.

The robot controller 110 receives the encoder signal ES in which the encoder output value is ek. The robot controller 110 calculates the absolute value of the difference between vk and ek as the evaluation value. The evaluation value at the timing tk corresponds to an example of the difference value. The robot controller 110 calculates a value obtained by subtracting the control allowable value from the evaluation value. The value obtained by subtracting the control allowable value from the evaluation value at the timing tk is a +value. The evaluation value is larger than the control allowable value.

When discriminating that the evaluation value is larger than the control allowable value, the robot controller 110 generates the modified control signal MCS. The robot controller 110 generates the modified control signal MCS in which the controller control value is ek. ek is the modified controller control value. The robot controller 110 sets the encoder output value as the modified controller control value. The robot controller 110 generates the modified control signal MCS including the modified controller control value in which the difference with the encoder output value at the timing tk is smaller than the evaluation value at the timing tk. The robot controller 110 generates, as an example, the modified control signal MCS in which the modified controller control value is ek. The modified control signal MCS in which the modified controller control value is ek corresponds to an example of the second control signal. The robot controller 110 transmits the modified control signal MCS in which the modified controller control value is ek to the motor driver 60 at the timing tk+1.

The motor driver 60 receives the modified control signal MCS in which the modified controller control value is ek. The motor driver 60 transmits the driver signal MS corresponding to the modified control signal MCS to the motor unit 40. The driver signal MS includes driver control value which is mk+1. The motor unit 40 receives the driver signal MS. The motor 41 decelerates the output shaft 43 based on the driver signal MS. When the motor 41 decelerates, the encoder 45 detects the rotational velocity of the output shaft 43. The motor unit 40 transmits the encoder signal ES in which the encoder output value is ek+1 to the motor driver 60. The motor driver 60 transmits the encoder signal ES in which the encoder output value is ek+1 to the robot controller 110 and the monitoring unit 120.

The robot controller 110 receives the encoder signal ES in which the encoder output value is ek+1. The robot controller 110 calculates the absolute value of the difference between ek and ek+1 as the evaluation value. The robot controller 110 calculates a value obtained by subtracting the control allowable value from the evaluation value. The value obtained by subtracting the control allowable value from the evaluation value at the timing tk+1 is a −value. The evaluation value is smaller than the control allowable value. The robot controller 110 generates the modified control signal MCS in which the modified controller control value is ek+1. The robot controller 110 transmits the modified control signal MCS in which the modified controller control value is ek+1 to the motor driver 60.

The monitoring unit 120 receives the modified control signal MCS in which the modified controller control value is ek and the encoder signal ES in which the encoder output value is ek+1. The monitoring unit 120 calculates the absolute value of the difference between ek and ek+1. The monitoring unit 120 compares the difference with the allowable value. The difference at the timing tk+1 is smaller than the control allowable value. The difference at the timing tk+1 is smaller than the allowable value. The monitoring unit 120 does not transmit the shutoff signal DS to the shutoff unit 80. The robot controller 110 can cause the motor 41 to perform the stop operation based on the control signal CS.

After the timing tk+1, the robot controller 110 generates the modified control signal MCS in which the encoder output value received immediately before is set as the modified controller control value. The robot controller 110 transmits the modified control signal MCS to the motor driver 60. The robot controller 110 causes the motor 41 to perform the stop operation by transmitting the modified control signal MCS. The robot controller 110 transmits the modified control signal MCS until the motor 41 stops. The motor 41 performs the stop operation based on the control of the robot controller 110.

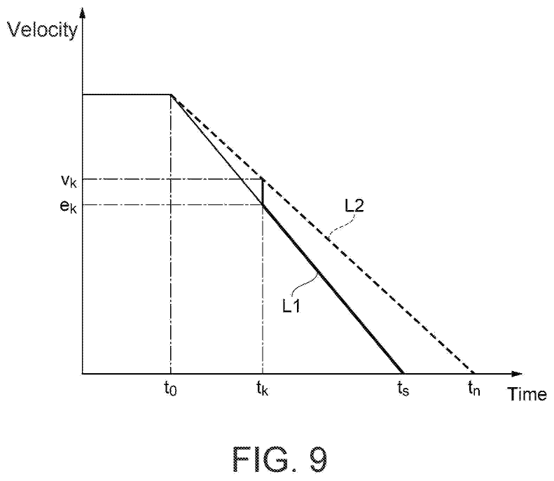

FIG. 9 shows the change with time of the rotational velocity of the output shaft 43. FIG. 9 shows the change in the rotational velocity when the robot controller 110 causes the motor 41 to execute the stop operation. FIG. 9 shows by the first change line L1, the rotational velocity change when the control signal CS including the controller control value shown in FIG. 8 and the modified control signal MCS are transmitted. FIG. 9 shows by a second change line L2, the change in the rotational velocity when the motor 41 is stopped using the control signal group for stopping the motor 41. The stop signal SS is output immediately before the timing t0.

The first change line L1 corresponds to the detection result of the encoder 45. The first change line L1 is equal or substantially equal to the actual measurement value of the rotational velocity of the output shaft 43. When using the control signal group, the robot controller 110 stops the output shaft 43 of the motor 41 at the timing tn as shown by the second change line L2. At the timing tk, the controller control value becomes Vk. At the timing tk, the encoder output value becomes ek.

After the timing tk, the difference between the first change line L1 and the second change line L2 further increases. When the difference exceeds the allowable value, the monitoring unit 120 transmits the shutoff signal DS to the shutoff unit 80. When the shutoff unit 80 shuts off the electric power to the motor unit 40 based on the shutoff signal DS, the motor 41 is stopped without being under control. When the motor 41 stops without being under control, the stop positions of the output shaft 43 and the arm become indefinite. It takes time to restart the robot 10 in some cases.

After the timing tk, the robot controller 110 generates the modified control signal MCS in which the controller control value included in the control signal CS is the encoder output value received immediately before. The encoder output value is used as the modified controller control value included in the modified control signal MCS. The robot controller 110 controls the stop operation of the motor 41 using the modified control signal MCS, thereby reducing the possibility that the monitoring unit 120 outputs the shutoff signal DS. The motor 41 performs the stop operation based on the control of the robot controller 110. The motor 41 stops at the timing ts. The timing ts is a shorter time than the timing tn.

In FIG. 8, the robot controller 110 sets the encoder output value after the timing tk+1 as the modified controller control value, but is not limited thereto. It is sufficient that the modified controller control value is a value closer to ek than to vk which is the controller control value included in the control signal CS at the timing tk. The difference between the modified controller control value and ek becomes smaller than the evaluation value which is the absolute value of the difference between vk and ek. The possibility that the monitoring unit 120 outputs the shutoff signal DS is reduced.

In FIG. 8, after the timing tk+1, the robot controller 110 generates and transmits the modified control signal MCS, but is not limited to this. When receiving the stop signal SS, the robot controller 110 may generate and transmit the modified control signal MCS.

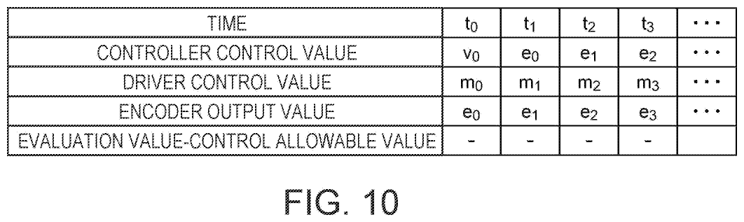

FIG. 10 shows controller control values and the like that are output at a predetermined timings. FIG. 10 shows the controller control value and the like when causing the motor 41 to execute the stop operation. FIG. 10 shows a case where the stop signal SS is received immediately before the timing t0 or the timing to.

When the stop signal SS is received at the timing t0, the robot controller 110 acquires the encoder output value e0 at the timing t0. The robot controller 110 transmits, to the motor driver 60, the control signal CS in which the controller control value is v0 and the stop signal SS. The motor driver 60 receives the control signal CS and the stop signal SS. The motor driver 60 transmits the driver signal MS corresponding to the control signal CS to the motor unit 40. The motor unit 40 receives the driver signal MS. The motor 41 rotates the output shaft 43 based on the driver signal MS. When the motor 41 rotates the output shaft 43, the encoder 45 detects the rotational velocity. The motor unit 40 generates the encoder signal ES in which the encoder output value is e0 and transmits the encoder signal ES to the motor driver 60. The motor driver 60 transmits the encoder signal ES in which the encoder output value is e0 to the robot controller 110 and the monitoring unit 120. The robot controller 110 receives the encoder signal ES in which the encoder output value is e0.

The robot controller 110 generates the control signal CS for causing the motor 41 to perform the stop operation. The robot controller 110 generates the modified control signal MCS using the encoder output value as the control signal CS for causing the motor 41 to perform the stop operation. At the timing t1, the robot controller 110 generates the modified control signal MCS in which the encoder output value is e0 as the modified controller control value. The robot controller 110 transmits the modified control signal MCS to the motor driver 60. The motor driver 60 receives the modified control signal MCS.

When the stop signal SS is received, the motor driver 60 generates the driver signal MS for stopping the motor 41. When the modified control signal MCS is received, the motor driver 60 transmits the driver signal MS to the motor unit 40. The motor unit 40 receives the driver signal MS. The motor 41 decelerates the output shaft 43 based on the driver signal MS. When the motor 41 decelerates the output shaft 43, the encoder 45 detects the rotational velocity. The motor unit 40 generates the encoder signal ES in which the encoder output value is e1 and transmits the encoder signal ES to the motor driver 60. The motor driver 60 transmits the encoder signal ES in which the encoder output value is e1 to the robot controller 110 and the monitoring unit 120.

The robot controller 110 receives the encoder signal ES in which the encoder output value is e1. The robot controller 110 generates the modified control signal MCS in which e1 as the controller control value. At the timing t2, the robot controller 110 transmits the modified control signal MCS in which e1 as the controller control value to the motor driver 60. The robot controller 110 transmits the modified control signal MCS in which the encoder output value as the controller control value to the motor driver 60 after the timing t1. The robot controller 110 causes the motor 41 to perform the stop operation by transmitting the modified control signal MCS. The robot controller 110 transmits the modified control signal MCS to the motor driver 60 at a predetermined timing. The robot controller 110 can cause the motor 41 to perform the stop operation under the control of the robot controller 110 by transmitting the modified control signal MCS at a predetermined timing.

The robot 10 includes the motor 41 having the output shaft 43, the robot controller 110 configured to transmit the control signal CS to the motor 41 at a predetermined timing, the encoder 45 that is configured to detect the operation of the motor 41 based on the control signal CS and that is output the encoder signal ES, and the monitoring unit 120 that is configured to receive the control signal CS and the encoder signal ES, that is configured to compare the difference between the control signal CS and the encoder signal ES with a predetermined allowable value, and that is configured to, when the difference is larger than the allowable value, output the shutoff signal DS. When causing the motor 41 to execute a predetermined operation, the robot controller 110 transmits the control signal CS in which the controller control value is vk to the motor 41, receives from the encoder 45 the encoder signal ES in which the encoder output value is ek based on the control signal CS in which the controller control value is vk, generates the modified control signal MCS in which the modified controller control value is ek that the difference from the encoder signal ES in which the encoder output value is ek is smaller than a evaluation value between the control signal CS in which the controller control value is vk and the encoder signal ES in which the encoder output value is ek, and transmits the modified control signal MCS in which the modified controller control value is ek to the motor 41 and the monitoring unit 120 receives the modified control signal MCS in which the modified controller control value is ek from the robot controller 110 and compares the difference between the modified control signal MCS in which the modified controller control value is ek and the encoder signal ES with the allowable value.

When performing a predetermined operation, the motor 41 operates based on the control of the robot controller 110. The position of the arm driven by the motor 41 is controlled. The robot 10 can perform restarting or the like in a short time after performing a predetermined operation. Since the difference between the modified controller control value and ek becomes smaller than the evaluation value, which is the absolute value of the difference between vk and ek, the possibility that the monitoring unit 120 outputs the shutoff signal DS is reduced. In other words, the possibility of the motor 41 being stopped is reduced by stopping the supply of the electric power, and the stop position of the rotation shaft of the motor 41 is suppressed from becoming indefinite.

The robot controller 110 stores the control allowable value smaller than the allowable value, calculates the evaluation value between the control signal CS in which the controller control value is vk and the encoder signal ES in which the encoder output value is ek, and generates the modified control signal MCS in which the modified controller control value is ek, when the evaluation value is larger than the control allowable value.

The robot controller 110 can control the motor 41 while maintaining a state in which the monitoring unit 120 does not output the shutoff signal DS.

The robot 10 includes the stop switch 150 configured to output the stop signal SS according to the input operation of the user, wherein the predetermined operation is the stop operation based on the stop signal SS output from the stop switch 150.

When the user performs the stop operation such as an emergency stop, the robot controller 110 can stop the motor 41 and the arm of the motor 41 at a predetermined position.

The encoder signal ES desirably includes the rotational velocity of the output shaft 43.

The robot controller 110 can perform control while confirming the rotational velocity of the output shaft 43.

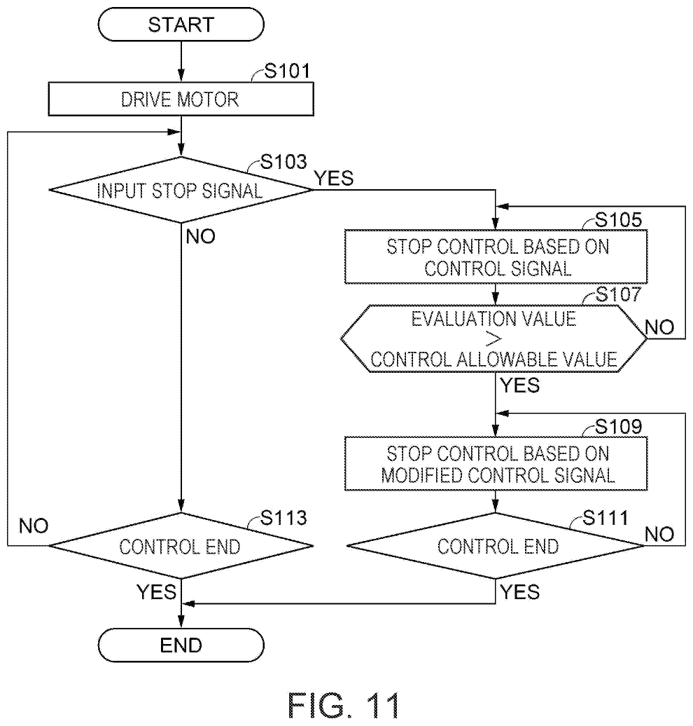

FIG. 11 shows a control flow executed by the robot 10. FIG. 11 shows the control flow when the motor 41 executes the stop operation. FIG. 11 is the flowchart showing the control flow executed by the control unit 100. The control flow corresponds to an example of a method of controlling the robot 10.

The robot 10 drives the motor 41 in step S101. The robot controller 110 of the robot 10 operates the motor unit 40 including the motor 41 based on the control signal CS. When the motor 41 operates, the robot arm 20 performs a predetermined operation.

While the motor 41 is driven, the robot 10 discriminates whether or not the stop signal SS is input in step S103. As an example, the robot 10 receives the stop signal SS immediately before the timing t0. When the user performs the input operation to the stop switch 150, the stop switch 150 transmits the stop signal SS to the robot controller 110. The robot controller 110 receives the stop signal SS transmitted from the stop switch 150. When the robot 10 discriminates that the stop signal SS has been input, the robot 10 proceeds to step S105 (step S103: YES). When it is discriminated that the stop signal SS has not been input, the robot 10 proceeds to step S113 (step S103:NO).

When the stop signal SS is input, the robot 10 performs stop control based on the control signal CS in step S105. The robot controller 110 generates the control signal group including the control signal CS for stopping the motor 41. The control signal CS includes the controller control value. The robot controller 110 transmits the control signal CS included in the control signal group to the motor driver 60 at a predetermined timing. The motor driver 60 receives the control signal CS. The motor driver 60 transmits the driver signal MS corresponding to the control signal CS to the motor unit 40. The motor unit 40 receives the driver signal MS. The motor 41 performs the stop operation based on the driver signal MS. When the motor 41 decelerates based on the driver signal MS, the encoder 45 detects the rotational velocity. The motor unit 40 generates the encoder signal ES including the rotational velocity as the encoder output value. The motor unit 40 transmits the encoder signal ES to the motor driver 60. The motor driver 60 transmits the encoder signal ES to the robot controller 110 and the monitoring unit 120.

When the encoder signal ES is received, the robot 10 compares the evaluation value with the control allowable value in step S107. The robot controller 110 discriminates whether or not the evaluation value is larger than the control allowable value.

As an example, the robot controller 110 calculates the evaluation value between the control signal CS in which the controller control value is v1 and the encoder signal ES in which the encoder output value is e1 at the timing t1. The robot controller 110 discriminates that the evaluation value is smaller than the control allowable value. When the evaluation value is smaller than the control allowable value, the robot 10 returns to step S105 (step S107:NO).

As an example, the robot controller 110 calculates the evaluation value between the control signal CS in which the controller control value is vk and the encoder signal ES in which the encoder output value is ek at the timing tk. The robot controller 110 determines that the evaluation value is larger than the control allowable value. When the evaluation value is larger than the control allowable value, the robot 10 proceeds to step S109 (step S107:YES).

In step S109, the robot 10 performs the stop control based on the modified control signal MCS. The robot controller 110 generates the modified control signal MCS including the modified controller control value. The robot controller 110 generates, as an example, the modified control signal MCS in which the encoder output value received immediately before is set as the modified controller control value. The robot controller 110 acquires the control signal CS in which the controller control value is vk and the encoder signal ES in which the encoder output value is ek at the timing tk. The robot controller 110 may generate the modified control signal MCS including the modified controller control value having a smaller difference from ek than the evaluation value between vk and ek. The robot controller 110 transmits the modified control signal MCS to the motor driver 60. The robot controller 110 performs the stop control of the motor 41 by transmitting the modified control signal MCS to the motor driver 60.

In step S111, the robot 10 discriminates whether the control has ended. The robot controller 110 discriminates whether or not the stop control has ended based on the encoder signal ES. When the encoder output value included in the encoder signal ES is 0, the robot controller 110 discriminates that the stop control has ended (step S111:YES). The robot 10 ends the control. When the encoder output value included in the encoder signal ES is not 0, the robot controller 110 discriminates that the stop control has not ended (step S111:NO). The robot 10 returns to step S109.

In step S113, the robot 10 discriminates whether the control has ended. The robot controller 110 discriminates whether or not the operation based on the control signal CS has ended based on the encoder signal ES. When the control by the control signal CS has ended, the robot controller 110 discriminates that the control has ended (step S113:YES). The robot 10 ends the control. When the control by the control signal CS has not ended, the robot controller 110 discriminates that the control is not ended (step S113:NO). The robot 10 returns to step S103.

Here, a configuration has been described in which the process returns to step S105 when the evaluation value is smaller than the control allowable value (step S107: NO) in step S107, but is not limited to this. For example, after discriminating that the evaluation value is smaller than the control allowable value (step S107:NO), the robot controller 110 may discriminate whether or not the stop control has ended based on the encoder signal ES. Further, when the encoder output value included in the encoder signal ES is 0, the robot controller 110 may discriminate that the stop control has ended, and the robot 10 may end the control.

The robot 10 includes the motor 41 operating based on the control signal CS, the encoder 45 that is configured to detect the operation of the motor 41 based on the control signal CS and that is configured to output the encoder signal ES, and the monitoring unit 120 that is configured to compare the difference between the control signal CS and the encoder signal ES based on the control signal CS with the allowable value and that is configured to, when the difference is larger than the allowable value, output the shutoff signal DS. The control method of the robot 10 includes when executing the stop operation which is a predetermined operation, transmitting the control signal CS in which the controller control value is vk to the motor 41, receiving from the encoder 45 the encoder signal ES in which the encoder output value is ek based on the control signal CS in which the controller control value is vk, generating the modified control signal MCS in which the modified controller control value is ek that the difference from the encoder signal ES in which the encoder output value is ek is smaller than the evaluation value between the control signal CS in which the controller control value is vk and the encoder signal ES in which the encoder output value is ek, transmitting the modified control signal MCS in which the modified controller control value is ek to the motor 41, receiving from the encoder 45 the encoder signal ES in which the encoder output value is ek+1 based on the modified control signal MCS, and comparing the difference between the modified control signal MCS and the encoder signal ES in which the encoder output value is ek+1 with the allowable value.

When performing a predetermined operation, the motor 41 operates based on the control of the robot controller 110. The position of the arm operated by the motor 41 is controlled. The robot 10 can perform restarting or the like in a short time after performing a predetermined operation. Since the difference between the modified controller control value and ek becomes smaller than the evaluation value, which is the absolute value of the difference between vk and ek, the possibility that the monitoring unit 120 outputs the shutoff signal DS is reduced. In other words, the possibility of the motor 41 being stopped is reduced by stopping the supply of the electric power, and the stop position of the rotation shaft of the motor 41 is suppressed from becoming indefinite.

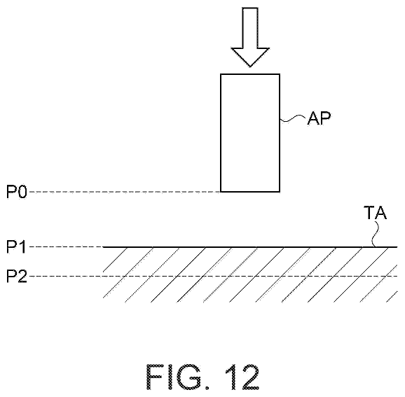

FIG. 12 shows an example of the workpiece manipulation performed by the robot 10. FIG. 12 shows a case where the robot 10 carries a component AP, which is an example of the workpiece, to a predetermined position. The robot 10 grips the component AP by the end effector (not shown). The robot 10 carries the component AP and places the component AP at a predetermined position on a table TA. The control unit 100 moves the robot arm 20 from a control start position P0 to a placement position P1 by torque control. The placement position P1 is the surface of the table TA.

The robot controller 110 generates the control signal group including the control signal CS. The control signal CS includes the controller control value. The controller control value is information for instructing the rotational position of the output shaft 43. The robot controller 110 uses the control signal CS to control the carry of the component AP.

When performing torque control, the robot controller 110 generates the control signal group to be moved to the control movement position P2. The robot controller 110 performs control to move the component AP to the control movement position P2 based on the control signal CS. When the robot controller 110 performs torque control, the motor 41 performs the torque control operation. The torque control operation corresponds to an example of a predetermined operation.

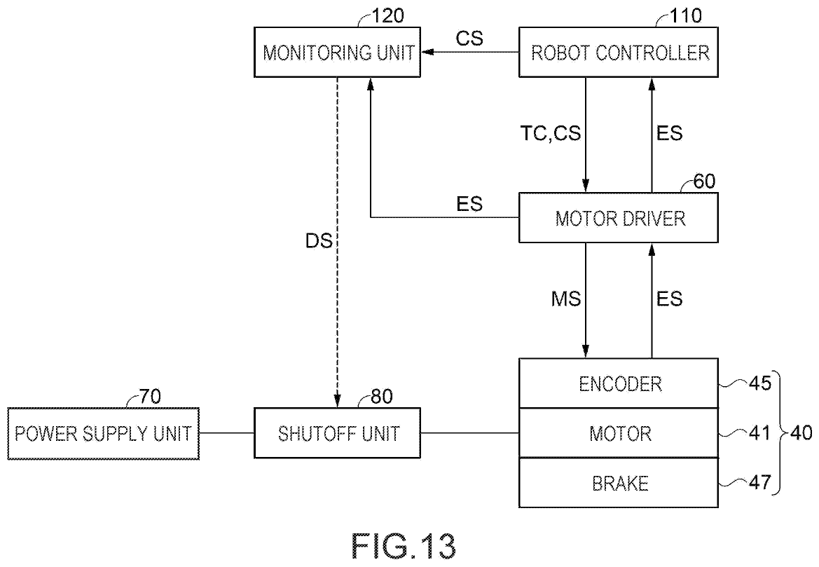

FIG. 13 schematically shows a block configuration of the robot 10. FIG. 13 shows a state where the robot controller 110 performs torque control. FIG. 13 shows the flow of each signal and the electric power supply state. The plurality of motor units 40 are controlled based on the flow of signals shown in FIG. 13. In FIG. 13, the area sensor 160 is omitted.

When operating the motor unit 40 by torque control, the robot controller 110 generates the control signal group including the series of control signals CS. The robot controller 110 transmits the control signal CS included in the control signal group to the motor driver 60 at a predetermined timing. The control signal CS includes, as an example, the controller control value indicating the rotational position of the output shaft 43 of the motor 41. When the robot controller 110 transmits the control signal CS to the motor driver 60, it transmits the control signal CS to the monitoring unit 120. When performing torque control, the robot controller 110 may generate a torque control signal TC indicating that torque control is to be performed. The robot controller 110 transmits the torque control signal TC to the motor driver 60.

The motor driver 60 receives the control signal CS and the torque control signal TC. The motor driver 60 generates the driver signal MS corresponding to the control signal CS. The driver signal MS is a signal that can be processed by the motor unit 40. The motor driver 60 generates the driver signal MS including the controller control value. The motor driver 60 transmits the driver signal MS to the motor unit 40.

The motor unit 40 receives the driver signal MS. The motor 41 included in the motor unit 40 rotates the output shaft 43 based on the controller control value included in the driver signal MS. The encoder 45 detects the rotational position of the output shaft 43, which rotates based on the controller control value, as the encoder output value. The motor unit 40 outputs the encoder signal ES including the encoder output value to the motor driver 60. The motor unit 40 may output the encoder signal ES to the monitoring unit 120.

The motor driver 60 receives the encoder signal ES including the encoder output value. The received encoder signal ES is a signal based on the control signal CS. The motor driver 60 transmits the encoder signal ES to the robot controller 110 and the monitoring unit 120. When the motor unit 40 directly transmits the encoder signal ES to the monitoring unit 120, the motor driver 60 may not transmit the encoder signal ES to the monitoring unit 120.

The monitoring unit 120 receives the control signal CS and the encoder signal ES based on the control signal CS. The monitoring unit 120 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80.

The robot controller 110 receives the encoder signal ES corresponding to the control signal CS. The robot controller 110 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value as the evaluation value.

The robot controller 110 reads out the allowable value stored in the memory 130. The robot controller 110 determines a control allowable value based on the allowable value. The control allowable value may be stored in the memory 130 in advance. If the control allowable value is stored in the memory 130, the robot controller 110 reads the control allowable value from the memory 130. The robot controller 110 temporarily stores the control allowable value. The control allowable value is a value smaller than the allowable value. The control allowable value corresponds to an example of a second threshold.

The robot controller 110 compares the evaluation value with the control allowable value. When the evaluation value is smaller than the control allowable value, the robot controller 110 continues the stop operation of the motor 41 by using the control signal CS included in the control signal group. When the evaluation value is larger than the control allowable value, the robot controller 110 corrects the control signal CS and generates the modified control signal MCS. The modified control signal MCS includes a modified controller control value. As an example, the robot controller 110 generates the modified control signal MCS in which the encoder output value received immediately before the generation of the modified control signal MCS is set as the modified controller control value.

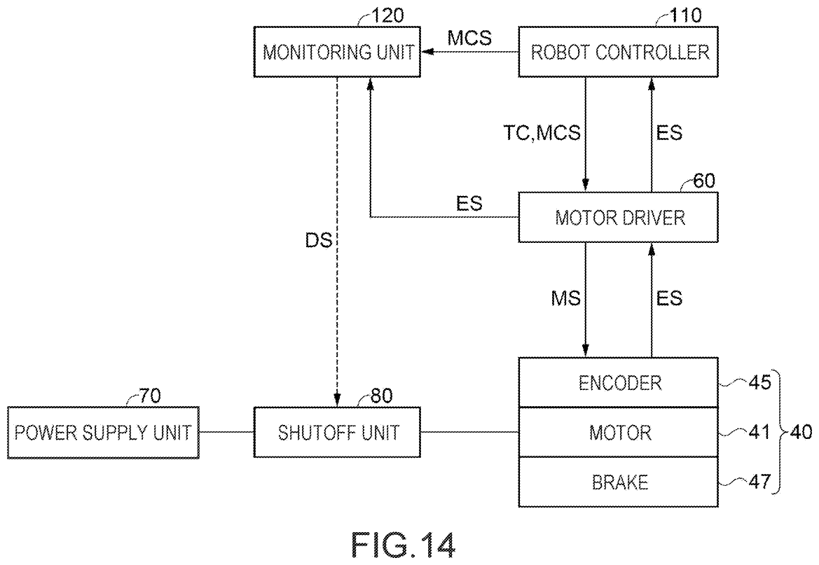

FIG. 14 schematically shows a block configuration of the robot 10. FIG. 14 shows a state when the robot controller 110 generates the modified control signal MCS. FIG. 14 shows the flow of each signal and the electric power supply state. The plurality of motor units 40 are controlled based on the flow of signals shown in FIG. 14. In FIG. 14, the area sensor 160 is omitted.

The robot controller 110 transmits the modified control signal MCS including the modified controller control value to the motor driver 60 at a predetermined timing. The robot controller 110 transmits the modified control signal MCS to the monitoring unit 120.

The motor driver 60 receives the modified control signal MCS. When the modified control signal MCS is received, the motor driver 60 transmits the driver signal MS to the motor unit 40. The motor driver 60 transmits the driver signal MS corresponding to the modified control signal MCS to the motor unit 40.

The motor unit 40 receives the driver signal MS. The motor 41 operates based on the driver signal MS. The encoder 45 detects the rotational position of the output shaft 43 when the motor 41 operates as the encoder output value. The motor unit 40 outputs the encoder signal ES including the encoder output value to the motor driver 60. The motor unit 40 may have a torque limiter (not shown). When a torque equal to or greater than a predetermined torque is applied to the motor 41, the motor unit 40 shuts off the load applied to the output shaft 43.

The motor driver 60 receives the encoder signal ES. The encoder signal ES corresponds to the modified control signal MCS. The motor driver 60 transmits the encoder signal ES to the robot controller 110 and the monitoring unit 120. When the motor unit 40 directly transmits the encoder signal ES to the monitoring unit 120, the motor driver 60 may not transmit the encoder signal ES to the monitoring unit 120.

The monitoring unit 120 receives the modified control signal MCS and the encoder signal ES based on the modified control signal MCS. The monitoring unit 120 compares the modified control signal MCS with the encoder signal ES. The monitoring unit 120 compares the modified controller control value included in the modified control signal MCS with the encoder output value included in the encoder signal ES. The monitoring unit 120 calculates the difference between the modified controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80.

The modified controller control value included in the modified control signal MCS is the encoder output value received last time. The difference between the modified controller control value and the encoder output value based on the modified controller control value is smaller than the allowable value. The possibility that the monitoring unit 120 outputs the shutoff signal DS is reduced. By controlling the motor unit 40, the robot controller 110 can cause the motor 41 to perform the stop operation.

The robot controller 110 receives the encoder signal ES corresponding to the modified control signal MCS. The robot controller 110 acquires the encoder output value included in the encoder signal ES. The robot controller 110 generates the modified control signal MCS in which the acquired encoder output value as the modified controller control value. The robot controller 110 generates the modified control signal MCS including the encoder output value as the modified controller control value every time the encoder signal ES is received. The robot controller 110 operates the motor 41 by transmitting the modified control signal MCS to the motor driver 60.

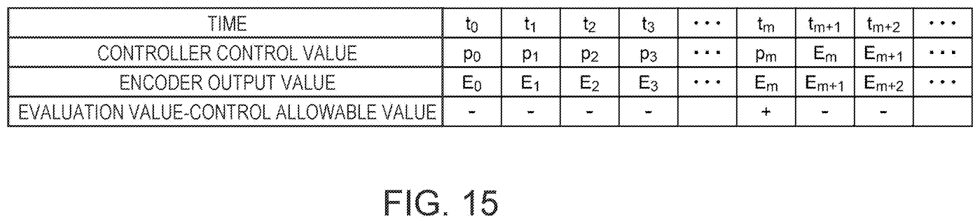

FIG. 15 shows the controller control value and the like that are output at predetermined timings. FIG. 15 shows the controller control values and the like when the motor 41 is caused to execute the torque control operation. FIG. 15 shows a case where the torque control operation is performed from the timing t0. The controller control value is included in the control signal CS. The encoder output value is a detection value output from the encoder 45 in response to the control signal CS including the controller control value. “EVALUATION VALUE-CONTROL ALLOWABLE VALUE” indicates the result of subtracting the control allowable value from the evaluation value at each time. “−” indicates that the evaluation value is smaller than the control allowable value. “+” indicates that the evaluation value is larger than the control allowable value.

When performing torque control, the robot controller 110 generates the control signal group for causing the motor 41 to execute the torque control operation. The robot controller 110 generates, as an example, the control signal group from the timing t0 to the timing tn. The control signal group is an n+1 data group. Here, n is an integer.

The robot controller 110 transmits the control signal CS and the torque control signal TC in which the controller control value is p0 to the motor driver 60 at the timing t0. p0 is an instruction value with respect to the rotational position of the output shaft 43 of the motor 41. In FIG. 15, the controller control value indicates the instruction value of the rotational position.

The motor driver 60 receives the control signal CS and the torque control signal TC in which the controller control value is p0. The motor driver 60 generates the driver signal MS when receiving the control signal CS. The driver signal MS includes the controller control value. When the motor driver 60 receives the control signal CS in which the controller control value is p0, it transmits the driver signal MS in which the controller control value is p0 to the motor unit 40.

The motor unit 40 receives the driver signal MS in which the controller control value is p0. The motor 41 drives the rotational position of the output shaft 43 toward p0 based on the driver signal MS. After the motor 41 is driven, the encoder 45 detects the rotational position of the output shaft 43. The encoder 45 detects that the encoder output value is E0. E0 indicates rotational position. The motor unit 40 outputs the encoder signal ES in which the encoder output value is E0 to the motor driver 60.

The motor driver 60 receives the encoder signal ES in which the encoder output value is E0. The motor driver 60 transmits the encoder signal ES to the robot controller 110 and the monitoring unit 120.

The robot controller 110 receives the encoder signal ES in which the encoder output value is E0. The robot controller 110 calculates the absolute value of the difference between p0 and E0 as the evaluation value. The robot controller 110 calculates a value obtained by subtracting the control allowable value from the evaluation value. The value obtained by subtracting the control allowable value from the evaluation value at the timing t0 is a −value. The evaluation value is smaller than the control allowable value. The robot controller 110 transmits the control signal CS included in the control signal group to the motor driver 60 at the timing t1. The control signal CS transmitted at the timing t1 is a signal in which the controller control value is p1. The robot controller 110 transmits the control signal CS at a predetermined timing and receives the encoder signal ES corresponding to the control signal CS from the motor driver 60.

The monitoring unit 120 receives the control signal CS in which the controller control value is p0 and the encoder signal ES in which the encoder output value is E0. The monitoring unit 120 calculates the absolute value of the difference between p0 and E0 as the difference. The monitoring unit 120 compares the difference with the allowable value. The difference at the timing t0 is smaller than the control allowable value. The difference at the timing t0 is smaller than the allowable value. The monitoring unit 120 does not transmit the shutoff signal DS to the shutoff unit 80. The robot controller 110 can cause the motor 41 to perform the stop operation based on the control signal CS.

The robot controller 110 transmits the control signal CS in which the controller control value is pm to the motor driver 60 at the timing tm. m is an integer smaller than n. The control signal CS in which the controller control value is pm corresponds to an example of the first control signal. The motor driver 60 receives the control signal CS in which the controller control value is pm. The motor driver 60 transmits the driver signal MS corresponding to the control signal CS to the motor unit 40. The motor unit 40 receives the driver signal MS. The motor 41 drives the output shaft 43 based on the driver signal MS. When the motor 41 is driven, the encoder 45 detects the rotational position of the output shaft 43. The motor unit 40 transmits the encoder signal ES in which the encoder output value is Em to the motor driver 60. The motor driver 60 transmits the encoder signal ES in which the encoder output value is Em to the robot controller 110 and the monitoring unit 120. The encoder signal ES in which the encoder output value is Em corresponds to an example of a first detection value.

The robot controller 110 receives the encoder signal ES in which the encoder output value is Em. The robot controller 110 calculates the absolute value of the difference between pm and Em as the evaluation value. The evaluation value at the timing tm corresponds to an example of the difference value. The robot controller 110 calculates a value obtained by subtracting the control allowable value from the evaluation value. The value obtained by subtracting the control allowable value from the evaluation value at the timing tm is a +value. The evaluation value is larger than the control allowable value.

When discriminating that the evaluation value is larger than the control allowable value, the robot controller 110 generates the modified control signal MCS. The robot controller 110 generates the modified control signal MCS in which the controller control value is Em. Em is the modified controller control value. The robot controller 110 sets the encoder output value as the modified controller control value. The robot controller 110 generates the modified control signal MCS including the modified controller control value in which the difference with the encoder output value at the timing tm is smaller than the evaluation value at the timing tm. The robot controller 110 generates the modified control signal MCS in which the modified controller control value is Em. The modified control signal MCS in which the modified controller control value is Em corresponds to an example of the second control signal. The robot controller 110 transmits the modified control signal MCS in which the modified controller control value is Em to the motor driver 60 at the timing tm+1.

The motor driver 60 receives the modified control signal MCS in which the modified controller control value is Em. The motor driver 60 transmits the driver signal MS corresponding to the modified control signal MCS to the motor unit 40. The motor unit 40 receives the driver signal MS. The motor 41 drives the output shaft 43 based on the driver signal MS. When the motor 41 is driven, the encoder 45 detects the rotational position of the output shaft 43. The motor unit 40 transmits the encoder signal ES in which the encoder output value is Em+1 to the motor driver 60. The motor driver 60 transmits the encoder signal ES in which the encoder output value is Em+1 to the robot controller 110 and the monitoring unit 120.

The robot controller 110 receives the encoder signal ES in which the encoder output value is Em+1. The robot controller 110 calculates the absolute value of the difference between Em and E m+1 as the evaluation value. The robot controller 110 calculates a value obtained by subtracting the control allowable value from the evaluation value. The value obtained by subtracting the control allowable value from the evaluation value at the timing tm+1 is a −value. The evaluation value is smaller than the control allowable value. The robot controller 110 generates the modified control signal MCS in which the modified controller control value is Em+1. The robot controller 110 transmits the modified control signal MCS in which the modified controller control value is Em+1 to the motor driver 60.

The monitoring unit 120 receives the modified control signal MCS in which the modified controller control value is Em and the encoder signal ES in which the encoder output value is Em+1. The monitoring unit 120 calculates the absolute value of the difference between Em and Em+1 as the difference. The monitoring unit 120 compares the difference with the allowable value. The difference at the timing tm+1 is less than the control allowable value. The difference at the timing tm+1 is less than the allowable value. The monitoring unit 120 does not transmit the shutoff signal DS to the shutoff unit 80. The robot controller 110 can cause the motor 41 to perform the stop operation based on the control signal CS.

After the timing tm+1, the robot controller 110 generates the modified control signal MCS in which the encoder output value received immediately before is set as the modified controller control value. The robot controller 110 transmits the modified control signal MCS to the motor driver 60. The robot controller 110 causes the motor 41 to execute the torque control operation by transmitting the modified control signal MCS and the motor 41 executes the torque control operation based on the control of the robot controller 110.

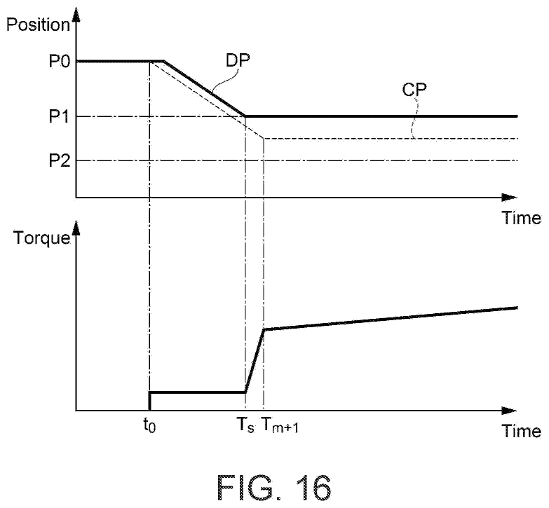

FIG. 16 schematically shows changes over time of the position of the component AP and the torque applied to the motor 41. The robot controller 110 moves the component AP by the torque control shown in FIGS. 13, 14, and 15. FIG. 16 shows a positional change of the component AP when the robot arm 20 moves the component AP. FIG. 16 shows a variation in the torque applied to the motor 41 when the robot arm 20 moves the component AP. FIG. 16 shows a detection position DP detected by the encoder 45 and a controller control position CP which is the controller control value.

The robot controller 110 causes the motor 41 to execute the torque control operation from the timing t0. At the timing t0, the lower end of the component AP is positioned at the control start position P0. After the timing t0, the robot controller 110 transmits the control signal CS included in the control signal group to the motor driver 60. The robot controller 110 drives the motor 41 by transmitting the control signal CS to the motor driver 60. When the motor 41 is driven, the encoder 45 detects the rotational position of the output shaft 43.

After the timing t0, the robot controller 110 lowers the component AP. The component AP is lowered from the control start position P0 to the placement position P1. At the timing ts, the component AP reaches the placement position P1. s is an integer smaller than m. After reaching the placement position P1, the component AP is positioned at the placement position P1. The robot controller 110 continuously transmits the control signal CS for movement to the control movement position P2 to the motor driver 60. The robot controller 110 performs control to lower the component AP to the control movement position P2 below the placement position P1. The robot controller 110 applies stress to the component AP to hold it at a predetermined position.

After the timing ts, the torque applied to the motor 41 increases under the control of the robot controller 110. At the timing tm, the robot controller 110 judges that the evaluation value is larger than the control allowable value. The robot controller 110 generates the modified control signal MCS including the modified controller control value. The modified controller control value is converted to the encoder output value received immediately before. The robot controller 110 transmits the modified control signal MCS to the motor driver 60 after the timing tm+1. After the timing tm+1, a rapid increase in the torque applied to the motor 41 is suppressed.

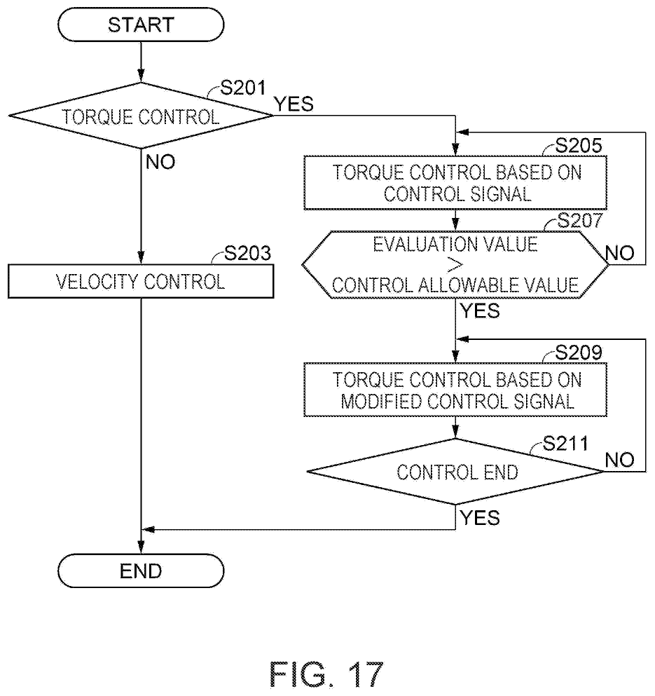

FIG. 17 shows a control flow executed by the robot 10. FIG. 17 shows the control flow when the motor 41 executes the torque control operation. FIG. 17 is a flowchart showing the control flow executed by the control unit 100. The control flow corresponds to an example of a method of controlling the robot 10.

In step S201, the robot 10 discriminates whether or not to drive the motor unit 40 by torque control. The robot controller 110 discriminates whether or not to cause the motor 41 included in the motor unit 40 to execute the torque control operation. When the robot controller 110 discriminates not to operate the motor unit 40 by torque control, the robot controller 110 proceeds to step S203 (step S201:NO). When the robot controller 110 discriminates to operate the motor unit 40 by torque control, the process proceeds to step S205 (step S201:YES).

In step S203, the robot 10 drives the motor unit 40 by velocity control. The robot controller 110 operates the motor 41 by velocity control drive. The robot controller 110 may drive the motor 41 by control other than velocity control.

In step S205, the robot 10 performs torque control based on the control signal CS. The robot controller 110 generates the control signal group including the control signal CS for controlling the torque of the motor 41. The control signal CS includes the controller control value. The robot controller 110 transmits the control signal CS included in the control signal group to the motor driver 60 at a predetermined timing. The motor driver 60 receives the control signal CS. The motor driver 60 transmits the driver signal MS corresponding to the control signal CS to the motor unit 40. The motor unit 40 receives the driver signal MS. The motor 41 performs the torque control operation based on the driver signal MS. When the motor 41 is driven based on the driver signal MS, the encoder 45 detects the rotational position. The motor unit 40 generates the encoder signal ES in which the rotational position is the encoder output value. The motor unit 40 outputs the encoder signal ES to the motor driver 60. The motor driver 60 transmits the encoder signal ES to the robot controller 110 and the monitoring unit 120.

When the encoder signal ES is received, the robot 10 compares the evaluation value with the control allowable value in step S207. The robot controller 110 discriminates whether or not the evaluation value is larger than the control allowable value.

As an example, the robot controller 110 calculates the evaluation value between the control signal CS in which the controller control value is p1 and the encoder signal ES in which the encoder output value is E1 at the timing t1. The robot controller 110 discriminates that the evaluation value is smaller than the control allowable value. When the evaluation value is smaller than the control allowable value, returns to step S205 (step S207:NO).

As an example, the robot controller 110 calculates the evaluation value between the control signal CS in which the controller control value is pm and the encoder signal ES in which the encoder output value is Em at the timing tm. The robot controller 110 determines that the evaluation value is larger than the control allowable value. When the evaluation value is larger than the control allowable value, proceeds to step S209 (step S207:YES).

In step S209, the robot 10 performs torque control based on the modified control signal MCS. The robot controller 110 generates the modified control signal MCS including the modified controller control value. The robot controller 110 generates, as an example, the modified control signal MCS in which the encoder output value received immediately before is set as the modified controller control value. The robot controller 110 acquires the control signal CS in which the controller control value is pm and the encoder signal ES in which the encoder output value is Em at the timing of tm. The robot controller 110 may generate the modified control signal MCS including the modified controller control value having a smaller difference with Em than the evaluation value between pm and Em. The robot controller 110 transmits the modified control signal MCS to the motor driver 60. The robot controller 110 performs the torque control operation of the motor 41 by transmitting the modified control signal MCS to the motor driver 60.

In step S211, the robot 10 discriminates whether the control has ended. The robot controller 110 discriminates whether or not torque control has ended based on the encoder signal ES. When the robot controller 110 discriminates that torque control has ended, ends the control (step S211:YES). When the robot controller 110 discriminates that torque control is not ended, returns to step S209 (step S211:NO).

Here, a configuration has been described in which the process returns to step S205 when the evaluation value is smaller than the control allowable value (step S207: NO) in step S207, but is not limited to this. For example, the robot controller 110 may discriminate whether or not torque control has ended based on the encoder signal ES after discriminating that the evaluation value is smaller than the control allowable value (step S207:NO). Further, the robot 10 may be configured to end the control when the robot controller 110 discriminates that torque control has ended.

The predetermined operation is desirably the torque control operation.

The robot controller 110 can control the driving of the motor 41 in a state in which the monitoring unit 120 does not output the shutoff signal DS.

The encoder signal ES desirably includes the rotational position of the output shaft 43.

The robot controller 110 can easily control the position of the workpiece such as the component AP.

### Second Embodiment

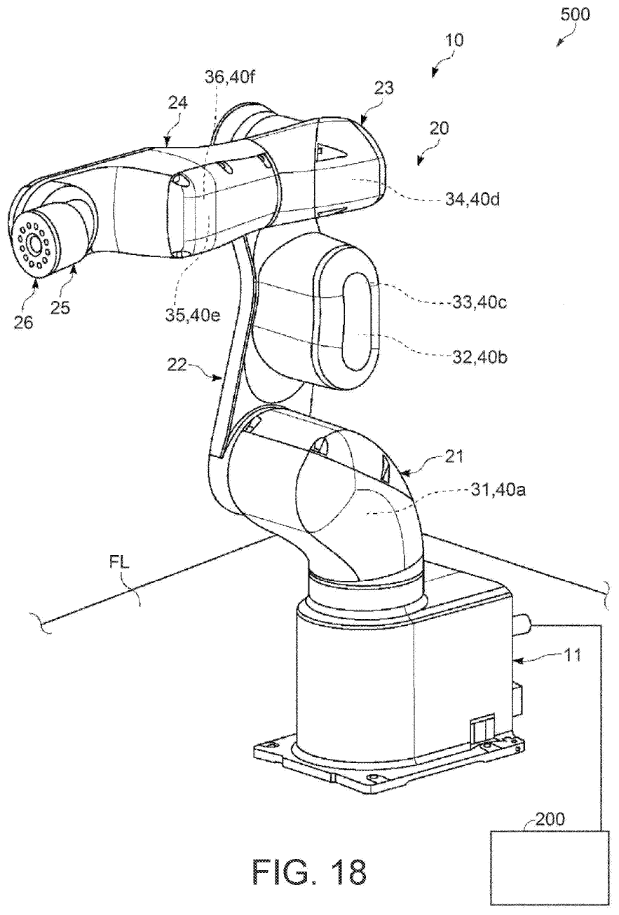

FIG. 18 shows a schematic configuration of a robot system 500. FIG. 18 shows the robot 10 and a control device 200. The robot system 500 shown in FIG. 18 is used in each work such as carry, assembly, and inspection of various workpieces.

The configuration of the robot 10 is shown in FIG. 18 is the same as that of the robot 10 shown in FIG. 1. The robot 10 is placed on the floor FL. The robot 10 is communicably connected with the control device 200.

The control device 200 controls the operation of the robot 10. The control device 200 is configured separately from the robot 10. The control device 200 is communicably connected to the robot 10. The control device 200 is communication connection with the robot 10 via a cable. The control device 200 may be communication connection with the robot 10 in a wireless manner. The control device 200 supplies electric power to the robot 10 via a cable. The control device 200 corresponds to an example of a robot control device.

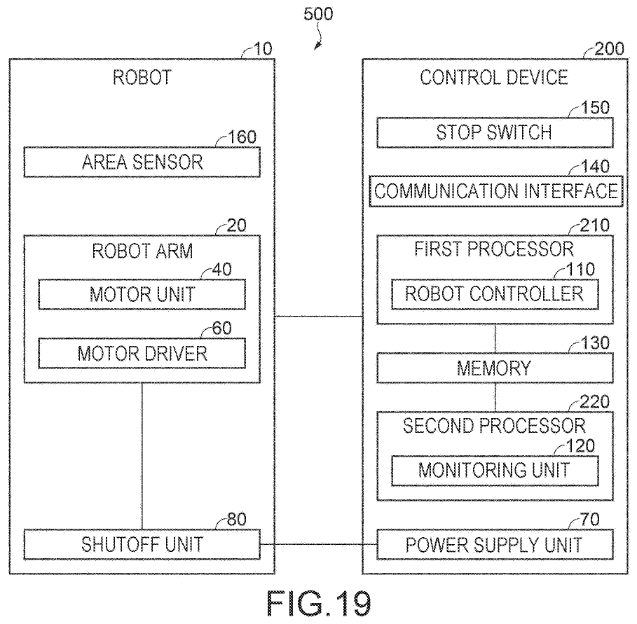

FIG. 19 shows a block configuration of the robot system 500. FIG. 19 shows an example of the arrangement of the units and the like included in the robot 10 and the control device 200. The arrangement of the units and the like is not limited to the configuration of FIG. 19.

The robot 10 includes the robot arm 20, the shutoff unit 80, and the area sensor 160. The robot arm 20 includes the motor unit 40 and the motor driver 60. The robot arm 20, the motor unit 40, the motor driver 60, the shutoff unit 80, and the area sensor 160 shown in FIG. 19 have the same configurations as the robot arm 20, the motor unit 40, the motor driver 60, the shutoff unit 80, and the area sensor 160 shown in FIG. 4.

The motor unit 40 has the motor 41, the encoder 45, and the brake 47. The motor 41 rotates the output shaft 43 based on the control signal CS transmitted from the motor driver 60. The encoder 45 generates the rotational position or the rotation angle of the output shaft 43 as the encoder signal ES. The motor unit 40 transmits the encoder signal ES to the motor driver 60.

The motor driver 60 receives the control signal CS transmitted from the robot controller 110 of the control device 200. The motor driver 60 transmits the driver signal MS based on the control signal CS to the motor unit 40. The motor driver 60 receives the encoder signal ES from the motor unit 40. The motor driver 60 transmits the encoder signal ES to the robot controller 110 of the control device 200 and the monitoring unit 120.

The shutoff unit 80 supplies or shuts off the electric power from the power supply unit 70 of the control device 200 to the motor unit 40. When receiving the shutoff signal DS output from the monitoring unit 120, the shutoff unit 80 shuts off the electric power supply to the motor unit 40.

The area sensor 160 detects the operation range of the robot arm 20 or each arm. When the robot arm 20 exceeds a predetermined operation range, the area error signal is transmitted to the control device 200.

The control device 200 includes the power supply unit 70, the memory 130, the communication interface 140, the stop switch 150, a first processor 210, and a second processor 220. The power supply unit 70, the memory 130, the communication interface 140, and the stop switch 150 shown in FIG. 19 have the same configurations as the power supply unit 70, the memory 130, the communication interface 140, and the stop switch 150 shown in FIG. 4.

The power supply unit 70 supplies electric power from the external power supply to each unit in the control device 200 and the robot 10. The power supply unit 70 supplies electric power to the motor unit 40 via the shutoff unit 80.

The memory 130 stores various data and the like. The memory 130 stores the robot control program to be executed by the first processor 210. The memory 130 stores the monitoring program to be executed by the second processor 220. The memory 130 stores various kinds of control data used in the robot controller 110. The memory 130 stores the monitoring data such as the allowable value used in the monitoring unit 120. The memory 130 stores the evaluation value calculated by the monitoring unit 120, the comparison result, and the like as the history data.

The communication interface 140 is an interface circuit for communication connection with an external device. The communication interface 140 is connected to the external device in a wired or wireless manner in accordance with a predetermined communication protocol.

The stop switch 150 is a switch on which the input operation is performed by the user of the robot system 500. As an example, when the robot arm 20 executes an unexpected operation, the user performs the input operation on the stop switch 150. When the input operation is performed, the stop switch 150 outputs the stop signal SS to the robot controller 110.

The first processor 210 is a processor circuit having the CPU. The first processor 210 functions as the robot controller 110 by executing the robot control program stored in the memory 130. The robot controller 110 is a functional section that operates in the first processor 210. The robot controller 110 shown in FIG. 19 has the same function as the robot controller 110 shown in FIG. 4.

The second processor 220 is a processor circuit having the CPU. The second processor 220 functions as the monitoring unit 120 by executing the monitoring program stored in the memory 130. The monitoring unit 120 is a functional section that operates in the second processor 220. The monitoring unit 120 shown in FIG. 19 has the same function as the monitoring unit 120 shown in FIG. 4.

The first processor 210 and the second processor 220 function as the control unit 100 shown in FIG. 4. In the configuration shown in FIG. 19, the first processor 210 and the second processor 220 are provided, but is not limited to this configuration. A single processor may serve as the control unit 100 shown in FIG. 4.

When the robot controller 110 causes the motor 41 to execute a predetermined operation, it generates the control signal group for operating the motor 41. The predetermined operation is the stop operation, the torque control operation, or the like. The robot controller 110 transmits the control signal CS included in the control signal group to the motor driver 60 at a predetermined timing.

The motor driver 60 receives the control signal CS. The motor driver 60 generates the driver signal MS corresponding to the control signal CS. The motor driver 60 transmits the driver signal MS to the motor unit 40.

The motor unit 40 receives the driver signal MS. The motor 41 operates based on the driver signal MS. The encoder 45 detects the rotational position or the rotational velocity of the output shaft 43 when the motor 41 operates as the encoder output value. The motor unit 40 outputs the encoder signal ES including the encoder output value to the motor driver 60.

The motor driver 60 receives the encoder signal ES. The encoder signal ES corresponds to the control signal CS. The motor driver 60 transmits the encoder signal ES to the robot controller 110 and the monitoring unit 120.

The monitoring unit 120 receives the control signal CS and the encoder signal ES based on the control signal CS. The monitoring unit 120 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value. The monitoring unit 120 compares the difference with the allowable value. When the monitoring unit 120 determines that the difference is smaller than the allowable value, the monitoring unit 120 judges that the motor 41 is operating normally. When the monitoring unit 120 determines that the difference is larger than the allowable value, the monitoring unit 120 judges that the motor 41 is operating abnormally. When the monitoring unit 120 determines that the difference is larger than the allowable value, the monitoring unit 120 outputs the shutoff signal DS to the shutoff unit 80.

The robot controller 110 receives the encoder signal ES corresponding to the control signal CS. The robot controller 110 compares the control signal CS with the encoder signal ES. The monitoring unit 120 compares the controller control value included in the control signal CS with the encoder output value included in the encoder signal ES. The monitoring unit 120 calculates the difference between the controller control value and the encoder output value as the evaluation value.

The robot controller 110 reads out the allowable value stored in the memory 130. The robot controller 110 determines a control allowable value based on the allowable value. The control allowable value may be stored in the memory 130 in advance. If the control allowable value is stored in the memory 130, the robot controller 110 reads the control allowable value from the memory 130. The robot controller 110 temporarily stores the control allowable value. The control allowable value is a value smaller than the allowable value.

The robot controller 110 compares the evaluation value with the control allowable value. When the evaluation value is smaller than the control allowable value, the robot controller 110 continues the operation of the motor 41 by using the control signal CS included in the control signal group. When the evaluation value is larger than the control allowable value, the robot controller 110 corrects the control signal CS and generates the modified control signal MCS.

The modified control signal MCS includes a modified controller control value. The modified control signal MCS is a signal that causes the motor 41 to stop operation. As an example, the robot controller 110 generates the modified control signal MCS in which the encoder output value received immediately before the generation of the modified control signal MCS is set as the modified controller control value. The robot controller 110 transmits the modified control signal MCS to the motor driver 60. The robot controller 110 controls the operation of the motor 41.

The robot system 500 includes the control device 200 and the robot 10. The control device 200 having the robot controller 110 configured to transmit the control signal CS at a predetermined timing and the monitoring unit 120 that is configured to compare the difference between the control signal CS and the encoder signal ES based on the control signal CS with the allowable value and that is configured to, when the difference is larger than the allowable value, output the shutoff signal DS. The robot 10 includes the motor 41 having the output shaft 43 and the encoder 45 configured to output the encoder signal ES based on the control signal CS. When causing the motor 41 to execute a predetermined operation, the robot controller 110 transmits the control signal CS, receives the encoder signal ES based on the control signal CS from the encoder 45, generates the modified control signal MCS in which the difference from the encoder signal ES is smaller than a evaluation value between the control signal CS and the encoder signal ES, and transmitting the modified control signal MCS to the motor 41 and the monitoring section receives the modified control signal MCS from the robot controller 110 and compares the difference between the modified control signal MCS and the encoder signal ES with the allowable value.

When performing a predetermined operation, the motor 41 operates based on the control of the robot controller 110. The position of the arm operated by the motor 41 is controlled. The robot 10 can perform restarting or the like in a short time after performing a predetermined operation. Since the difference between the modified control signal MCS and the encoder signal ES becomes smaller than the difference between the control signal CS and the encoder signal ES, the possibility that the monitoring unit 120 outputs the shutoff signal DS is reduced. In other words, the possibility of the motor 41 being stopped is reduced by stopping the supply of the electric power, and the stop position of the rotation shaft of the motor 41 is suppressed from becoming indefinite.

In FIG. 19, the shutoff unit 80 may be provided in the robot 10, but is not limited thereto. The shutoff unit 80 may be provided in the control device 200. The power supply unit 70 may be provided in the robot 10. The arrangement of each unit is appropriately set.

The invention claimed is:

1. A robot comprising:
a motor having a rotation shaft;
a controller configured to transmit a control signal to the motor at a predetermined timing;
an encoder that is configured to detect the operation of the motor based on the control signal and that is configured to output an output signal; and
a monitoring section that is configured to receive the control signal and the output signal, that is configured to compare the difference between the control signal and the output signal with a predetermined threshold, and that is configured to output a power shutoff command when the difference is larger than the threshold, wherein
when causing the motor to execute a predetermined operation,
the controller
transmits a first control signal to the motor as the control signal,
receives a first output signal based on the first control signal as the output signal from the encoder,
generates a second control signal in which the difference from the first output signal is smaller than a difference value that between the first control signal and the first output signal, and
transmits the second control signal as the control signal to the motor and the monitoring section
receives the second control signal as the control signal from the controller and
compares the difference between the second control signal and the output signal with the threshold.

2. The robot according to claim 1, wherein
the controller
stores a second threshold smaller than the threshold,
calculates the difference value between the first control signal and the first output signal, and
generates the second control signal when the difference value is larger than the second threshold.

3. The robot according to claim 1, further comprising:
a stop switch configured to output a stop command according to the input operation of a user, wherein
the predetermined operation is a stop operation based on the stop command output from the stop switch.

4. The robot according to claim 1, wherein
the predetermined operation is the torque control operation.

5. The robot according to claim 1, wherein
the output signal includes a rotational position of the rotation shaft.

6. The robot according to claim 1, wherein
the output signal includes a rotational velocity of the rotation shaft.

7. A robot system comprising:
a robot including
a robot control device having a controller configured to transmit a control signal at a predetermined timing and a monitoring section that is configured to compare the difference between the control signal and an output signal based on the control signal with a threshold and that is configured to, when the difference is larger than the threshold, output a power shutoff command,
a motor having a rotation shaft, and
an encoder configured to output the output signal based on the control signal, wherein
when causing the motor to execute a predetermined operation,
the controller
transmits a first control signal as the control signal,
receives a first output signal based on the first control signal as the output signal from the encoder,
generates a second control signal in which the difference from the first output signal is smaller than a difference value that between the first control signal and the first output signal, and
transmits the second control signal as the control signal to the motor and the monitoring section
receives the second control signal as the control signal from the controller and
compares the difference between the second control signal and the output signal with the threshold.

8. A method for controlling a robot, the robot including
a motor operating based on a control signal;
an encoder that is configured to detect the operation of the motor based on the control signal and that is configured to output an output signal; and
a monitoring section that is configured to compare a difference between the control signal and the output signal based on the control signal with a threshold and that is configured to, when the difference is larger than the threshold, output a power shutoff command,
the method comprising:
when executing a predetermined operation,
transmitting a first control signal to the motor as the control signal,
receiving a first output signal based on the first control signal as the output signal from the encoder,
generating a second control signal in which the difference from the first output signal is smaller than the difference value that between the first control signal and the first output signal,
transmitting the second control signal as the control signal to the motor,
receiving a second output signal based on the second control signal as the output signal from the encoder, and
comparing the difference between the second control signal and the output signal with the threshold.
